(19) United States
(12) Patent Application Publication
(10) Pub. No.: US 2010/0306708 A1
(43) Pub. Date: Dec. 2, 2010

(54) SYSTEMS AND METHODS FOR HANDLING PROFILES IN A COMMUNITY

(75) Inventors: Daniel Wright Trenz, Ann Arbor, MI (US); James Andrew Pozenel, Milan, MI (US); Donald Scott Brown, Rives Junction, MI (US); David Michael Levy, Chicago, IL (US); Emily Ann Sander, Chicago, IL (US); Grant Andrew Meyer, Brookfield, WI (US)

Correspondence Address: ROPES & GRAY LLP, PATENT DOCKETING 39/361, 1211 AVENUE OF THE AMERICAS, NEW YORK, NY, 10036-8704, US

(73) Assignee: Rovi Techonologies Corporation, Santa Clara, CA (US)

(21) Appl. No.: 12/570,218

(22) Filed: Sep. 30, 2009

Related U.S. Application Data
(60) Provisional application No. 61/182,567, filed on May 29, 2009.

(51) Int. Cl. G06F 3/048

(52) U.S. Cl. 715/853; 715/856

(57) ABSTRACT

Systems and methods for handling profiles in a community are provided. A profile hub-and-spoke arrangement may be provided which includes a profile representation associated with a user as the hub and one or more media asset representations as one or more spokes. The media asset representations that are included in the hub-and-spoke arrangement may match preferences of the user. As a cursor is positioned over various items of the hub-and-spoke arrangement, a window of information corresponding to the item may be provided. A selection of the item may be received and a new hub-and-spoke arrangement may be generated and displayed to correspond to the selected item. A similar media asset hub-and-spoke arrangement may be provided which includes a media asset representation as the hub and one or more community member representations as one or more spokes.

### CROSS-REFERENCE TO RELATED APPLICATION

This application claims the benefit of U.S. Provisional Application No. 61/182,567, filed May 29, 2009, the disclosure of which is hereby incorporated by reference herein in its entirety.

### BACKGROUND OF THE INVENTION

Traditional systems allow a user to create a preference profile to find programs that match the interests of the user. These systems may display titles of the programs that match the interests of the user in a list. However, the lists are generally alphabetical and are not organized to convey a great amount of information to the user with a given space on a display. For example, an alphabetical list may not inform the user as to the relevance of a particular program. In addition, these systems allow a user to see a list of programs that are relevant to the user but not whether the same programs match interests of other users.

### SUMMARY OF THE INVENTION

In view of the foregoing, systems and methods for handling profiles in a community in accordance with various embodiments of the present invention are provided. In particular, interactive hub-and-spoke arrangements are provided which visually link user profiles to media assets.

In some embodiments, a profile hub-and-spoke arrangement may be provided. A profile representation associated with a user may be displayed as the hub of the hub-and-spoke arrangement. The profile representation may be linked or joined to one or more media asset representations which may be displayed as one or more spokes of the hub-and-spoke arrangement. The media asset representations that are included in the hub-and-spoke arrangement may match preferences of the user. In some implementations, the distance between the hub and the spokes may be proportional or inversely proportional to the relevance between a profile associated with the user representation and the characteristics of media assets associated with the media asset representations.

In some embodiments, friends of the user or other community members that share characteristics with the user may be represented by community member identifiers. The community member identifiers may be displayed next to, about or around the profile hub-and-spoke arrangement.

In some embodiments, as the user positions a cursor over various items displayed in the screen, a window of information about the item may be provided. In particular, when the user positions a cursor over one of the displayed media asset representations, a window that includes a video clip, detailed information and/or various recording, scheduling and reminder options may be provided. In some implementations, the window may be displayed adjacent to the media asset representation over which the cursor is positioned. A selection of one of the spokes or media asset representations may be received. A new hub-and-spoke arrangement may be provided that is tailored to the selected media asset representation. In particular, the selected media asset representation may be displayed as the hub of the hub-and-spoke arrangement and community member identifiers may be displayed as the spokes.

In some implementations, when the user positions a cursor over one of the displayed community member identifiers, a window that includes information associated with the particular community member (e.g., username, full name, and/or profile attributes) may be provided. In some implementations, the window may be displayed adjacent to the community member identifier over which the cursor is positioned. A selection of one of the community member identifiers may be received. The hub-and-spoke arrangement may be changed to be tailored to the selected community member identifier. In particular, the selected community member identifier may be displayed as the hub of the hub-and-spoke arrangement and media asset representations that match preferences of the community member may be displayed as the spokes.

In some embodiments, a media asset hub-and-spoke arrangement may be provided. A media asset representation associated with a media asset may be displayed as the hub of the hub-and-spoke arrangement. The media asset representation may be linked or joined to one or more community member identifiers which may be displayed as one or more spokes of the hub-and-spoke arrangement. The community member identifiers that are included in the hub-and-spoke arrangement may have profiles that match attributes of the media asset. In some implementations, the distance between the hub and the spokes may be proportional or inversely proportional to the relevance between a profile associated with the community member identifiers and the characteristics of the media asset associated with the media asset representation.

In some embodiments, related media assets that share characteristics with the media asset corresponding to the media asset representation (in the hub) may be represented by related media asset identifiers. The related media asset identifiers may be displayed next to, about or around the media asset hub-and-spoke arrangement.

As with the profile hub-and-spoke arrangement, as the user positions a cursor over various items in the display, a window which includes information about the item may be provided. In particular, when the user positions a cursor over one of the displayed community member identifiers, a window that includes information about the community member may be provided.

In some embodiments, a search may be performed in the community based on an input search string and criteria. The results of the search may be displayed as an interactive search results hub-and-spoke arrangement. In particular, a representation of the search term may be provided as the hub of the results hub-and-spoke arrangement and representations of the various results may be displayed as the spokes of the results hub-and-spoke arrangement. In some implementations, the distance between each results representation (the spokes) and the search term (the hub) may indicate the relative match or relevance between that result and the search term.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative display screen of a home screen in accordance with an embodiment of the invention;

FIG. 6 shows an illustrative display of a hub-and-spoke arrangement associated with a particular user in accordance with an embodiment of the invention;

FIG. 7 is an illustrative display screen of a window providing information about a media asset corresponding to a media asset identifier in accordance with an embodiment of the invention;

FIG. 8 is an illustrative display screen of a window providing information about a community member corresponding to a community member identifier in accordance with an embodiment of the invention;

FIG. 9 is an illustrative profile data structure in accordance with an embodiment of the invention;

FIG. 10 is an illustrative media asset data structure in accordance with an embodiment of the invention;

FIGS. 11 and 12 show an illustrative display of a hub-and-spoke arrangement associated with a particular media asset in accordance with an embodiment of the invention;

FIG. 13 shows an illustrative display screen of community preferences as a whole in accordance with an embodiment of the invention;

FIG. 14 shows an illustrative display screen of region specific preferences in accordance with an embodiment of the invention; and

FIGS. 15 and 16 are illustrative flow diagrams for providing community based hub-and-spoke arrangements in accordance with embodiments of the present invention.

### DETAILED DESCRIPTION

This invention generally relates to systems and methods for handling profiles in a community. In particular, various hub-and-spoke arrangements are provided that allow a user to visually identify media assets match the interests of the user and that allow a user to visually identify users within a community have interests that match a particular media asset.

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

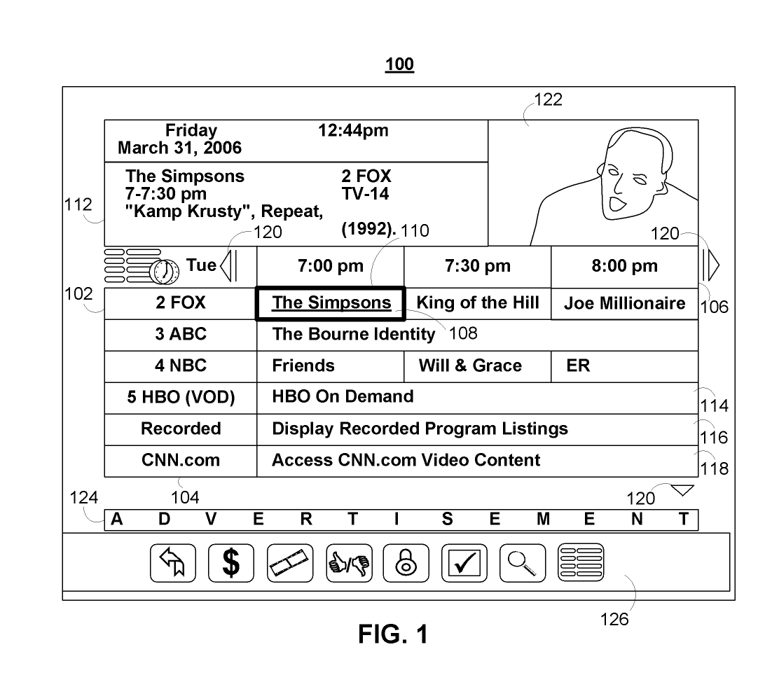

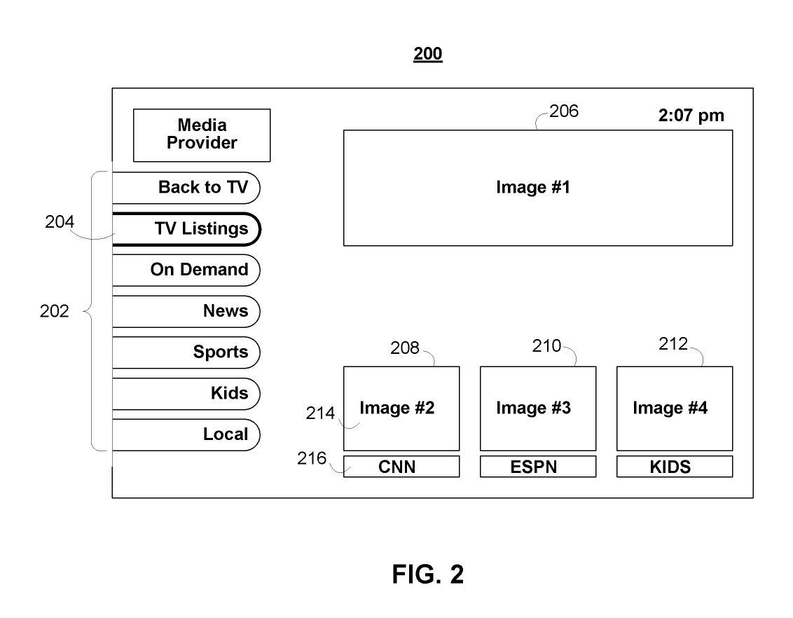

One of the functions of the media guidance application is to provide media listings and media information to users. FIGS. 1-2 show illustrative display screens that may be used to provide media guidance, and in particular media listings. The display screens shown in FIGS. 1-2, 5-8 and 11-14 may be implemented on any suitable device or platform. While the displays of FIGS. 1-2, 5-8 and 11-14 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site (e.g., HULU or YOUTUBE) or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to (i.e., be related to) or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, scheduling a reminder for a program, ordering a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. Pat. No. 7,165,098, issued Jan. 16, 2007, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, still frames of a video associated with the listing, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

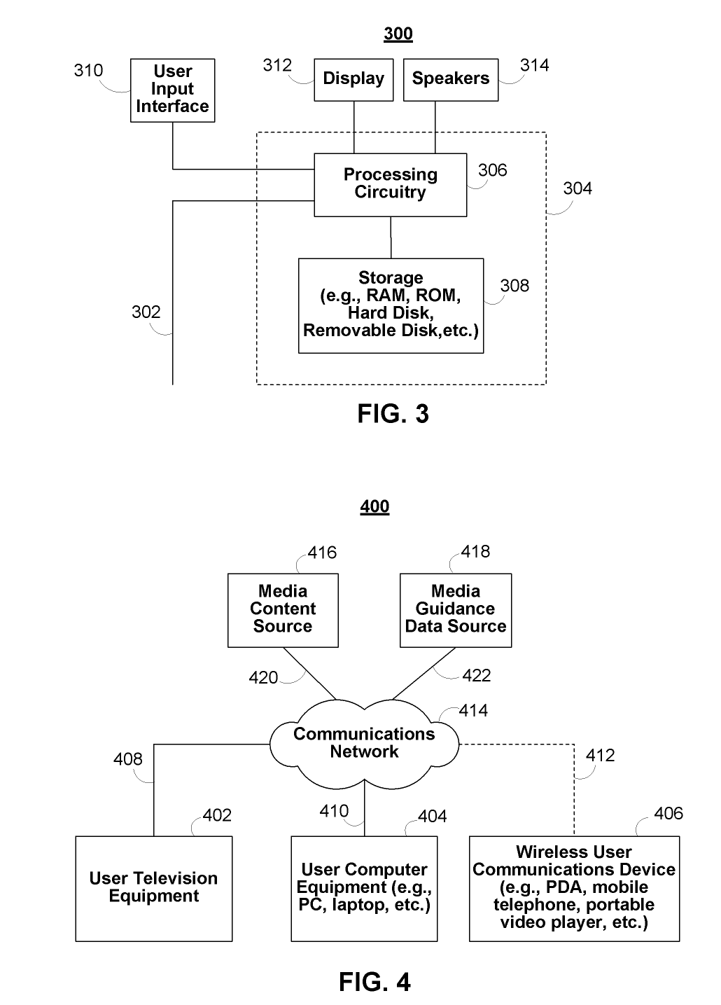

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content or scheduled media asset events (e.g., reminders for media assets). For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, program orders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

In some embodiments, the user may log into a website, server or computer to access a community network which may be referred to below as the system. The community network may be used to connect people from around the world based on their user profiles. In particular, the community network may allow the user to visually identify media assets that are relevant to the user and also identify other community members with interests in particular media assets. When the user initially logs into the system, a home screen may be displayed. The home screen may be used to access various portions and settings of the system or community network.

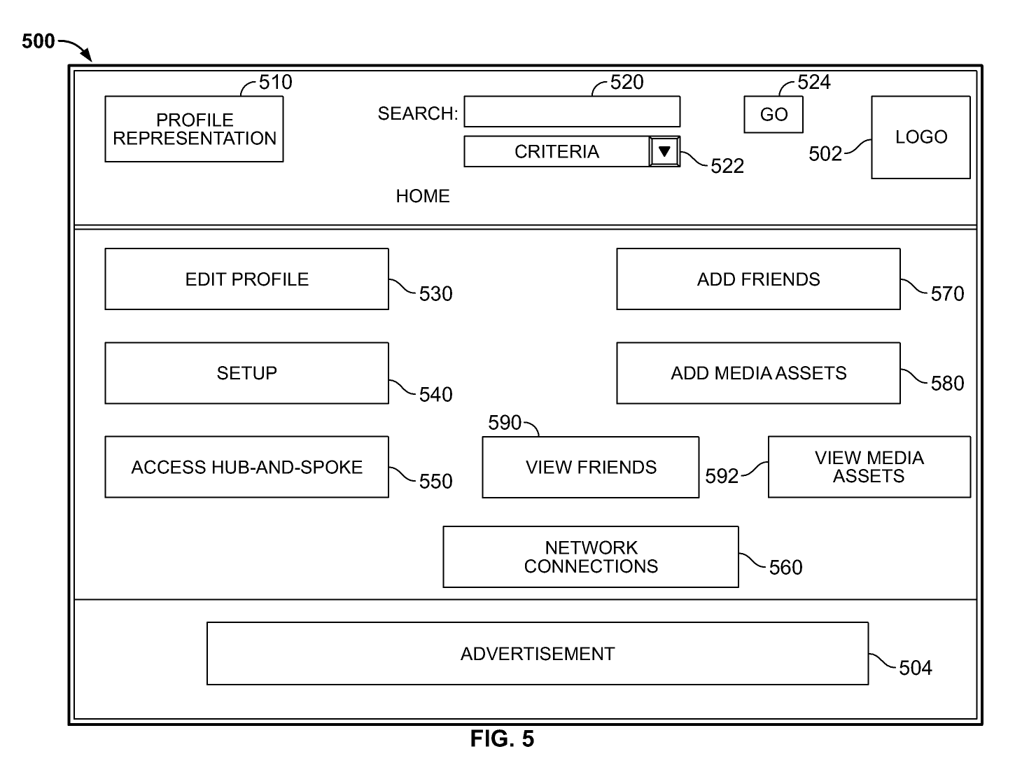

FIG. 5 shows an illustrative display screen 500 of a home screen in accordance with an embodiment of the invention. Home screen 500 may include a profile representation 510, edit profile option 530, setup option 540, access hub-and-spoke option 550, add friends option 570, add media assets option 580, view friends option 590, view media assets option 592 and network connections option 560.

Profile representation 510 may include a picture, video, icon, text or any combination thereof that uniquely identifies the user to other members on the network. For example, profile representation 510 may be an icon that is displayed on the screen when other members in the network browse through profiles. In some implementations, more than one community member on the network may have the same profile representation 510. In such circumstances, whenever the profile representation 510 is displayed for others on the network, an additional identifier may also be provided (e.g., a username or name associated with the community member corresponding to profile representation 510). In some embodiments, profile representation 510 may change dynamically over time depending on the mood of the user or based on a clock.

Through home screen 500, the user may select profile representation 510 (e.g., by positioning or navigating a mouse or cursor) to change or modify profile representation 510. Processing circuitry 306 may bring up a display screen either as a window next to profile representation 510 or as a new screen with options relating to profile representation 510. Processing circuitry 306 may receive a user selection indicating a change to profile representation 510. For example, processing circuitry 306 may receive a selection of an option to upload an image or video for use as profile representation 510. Alternatively or in addition, processing circuitry 306 may receive a selection of an option to dynamically change profile representation 510 by scrolling through different profile representation 510 selections over time (e.g., displaying a different one of the profile representations in a list every day or every other day).

Processing circuitry 306 may receive a user selection that associates a particular profile representation 510 with a mood of the user. For example, one image of the user being sad may be associated with a sad mood while another image of the user being happy may be associated with a happy mood. Processing circuitry 306 may query the user upon receiving valid login criteria about the mood of the user. Processing circuitry 306 may automatically select profile representation 510 based on the response of the user regarding the mood of the user. The selected profile representation 510 may be displayed during that session (e.g., until the user logs out) and may change to some other default profile representation when the user logs out. For example, processing circuitry 306 may display, for other community members, one type of profile representation 510 when the user is active (e.g., logged in) and may display, for the other users, a different profile representation 510 when the user is inactive (e.g., logged out). This may allow other community members on the system to determine whether they can communicate with the user in real-time (e.g., by way of instant messaging).

As used herein, the term “other user(s)” or “other community member(s)” refers to members on the network that are part of the same community as the user or associated or share a common attribute with the user. For example, the user may be the person at a particular workstation who may select or form a group of members on the network made up of the other users. Alternatively, the user may be one employee of a company and the other community members may be other employees of the same company. Although the above and below embodiments are described in terms of the other community members belonging to a shared community with the user (e.g., a company or circle of friends), the user may change a setting to cause the other community members to be any other person that is logged into the network regardless of association or shared attribute with the user (e.g., strangers). In some embodiments, a community refers to a collection of people (or their profiles) that are associated with each other by way of being friends, family members, colleagues, enemies, in a common geographic location, in a common class of individuals, part of an online social network (e.g., Friendster, Facebook, MySpace, etc.) and/or part of the same organization(s) (e.g., churches, political organizations, universities, colleges, unions, companies, or branches within companies).

Processing circuitry 306 may receive a selection of setup option 540 and may generate a window or new screen with settings that the user may select. For example, one of the settings may be a privacy setting which instructs processing circuitry 306 which other community members can access or view the profile of the user. In particular, a privacy setting may be modified to only allow other community members who belong to the same community (e.g., company) as the user (or may be broadened to allow any other community member) to access or view the user's profile. Another one of the settings may allow the user to change a username associated with the user and password. The username is the unique textual identifier associated with the user which other members of the network can see and use to identify the particular user. The username may or may not be the same as the actual name of the user. For example, the user Stewie Griffin may have a username that is “baby” which other members of the community see and use to identify Stewie Griffin.

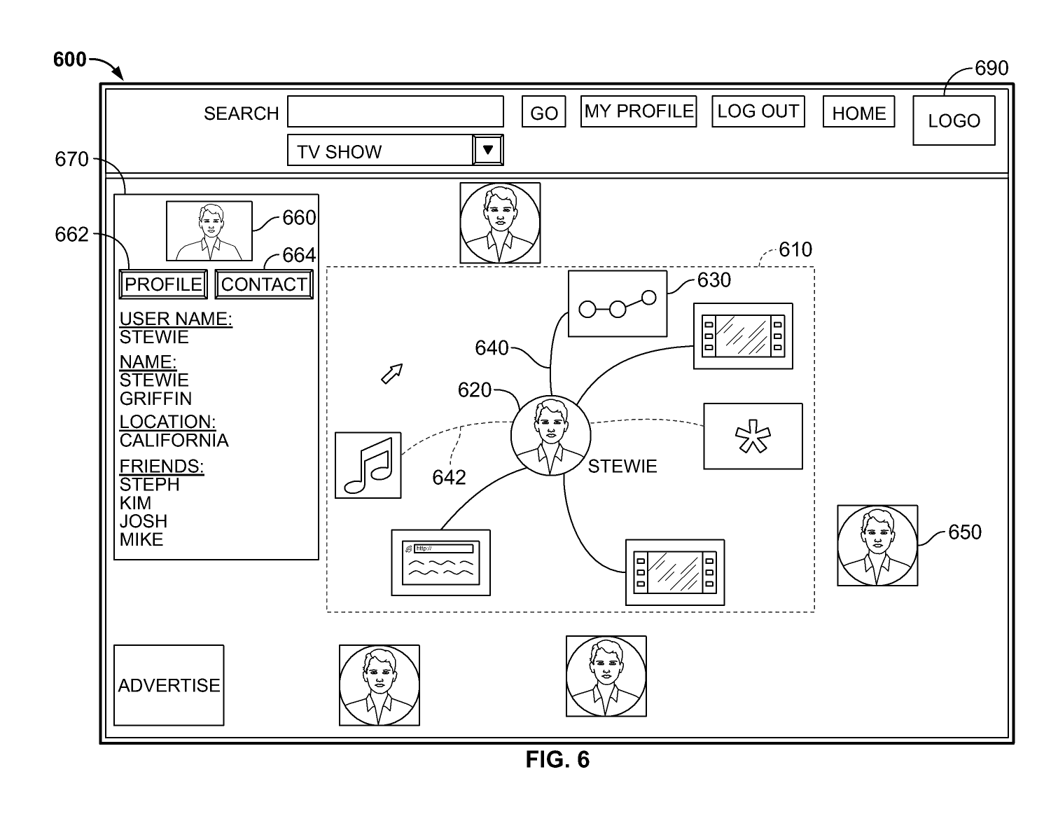

Another setting may allow the user to select which screen is displayed as the home screen after the user successfully logs into the network (e.g., by providing a username that matches a password). For example, processing circuitry 306 may retrieve the home screen setting to determine which screen to generate as the first screen for the user to access after validly or successfully logging in. In particular, processing circuitry may navigate the user to or generate any one of the screens of FIGS. 6-8 and 11-14 (described in detail below) as the first screen after the user logs in.

Another setting may allow a user to modify the way in which the hub-and-spoke arrangements (discussed below) are generated and displayed. For example, the user may instruct processing circuitry 306 to generate hub-and-spoke arrangements as perfect or substantially perfect circles (e.g., with the spokes surrounding the hub in a circle). In another embodiment, the user may instruct processing circuitry 306 to generate hub-and-spoke arrangements with different distances between the hub and the spokes based on relevance (e.g., closer spokes resembling better matches between preferences of a profile and characteristics of a media asset).

A logo 502 may also be displayed that identifies the provider of the network to the user. For example, logo 502 may be the trademark of the service (e.g., ROVI or FACEBOOK). An advertisement 504 may be displayed anywhere on screen 500 or any other screen discussed above and below. Advertisement 504 may be have similar functionality as advertisement 124 (FIG. 1).

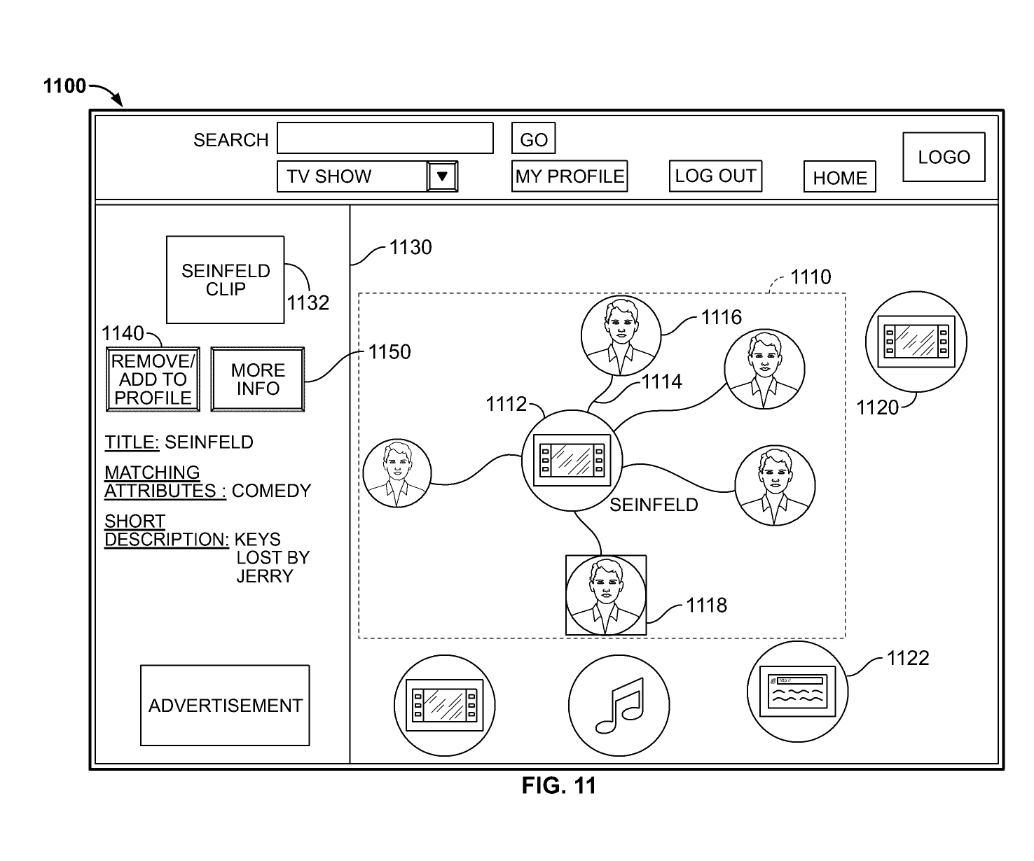

Processing circuitry 306 may receive a selection of add friends option 570. As a result, processing circuitry 306 may navigate a user to a new screen or display a window that allows the user to select or browse for other users or members on the network. For example, the user may input various search criteria for common interests (e.g., a common workgroup in a company) and view a list of other users that have that common interest. Processing circuitry 306 may receive a selection of a particular community member from the list to add to the user's group. When the particular community member is added to the user's group, that community member may be provided with access to the user's profile. When a particular community member is added to the group, processing circuitry 306 may include the added community member in the hub-and-spoke arrangements that are generated. In particular, the added community member may be included in the form of a community member identifiers as the spokes of the profiles of community members that have matching interests with a particular media asset (e.g., hub-and-spoke arrangement discussed in connection with FIG. 11).

Processing circuitry 306 may also include an interactive list of selectable community members that are already friends with the user when the user selects view friends option 590. The interactive list may be displayed in a window next to option 590 or in a new window to which the user is navigated. Processing circuitry 306 may receive a selection of any one of the friends in the interactive list to either delete the friend, view the profile of the friend or view a hub-and-spoke arrangement associated with the friend. For example, the user may access hub-and-spoke arrangements of friends to see which media assets match interests of another member. In particular, processing circuitry 306 may bring up a display similar to the one shown in FIG. 6 that shows the selected friend's profile representation in the center as the hub of the hub-and-spoke arrangement and media assets that match interests of the selected friend as the spokes.

The user may also delete friends from the list to disassociate a particular member from the user's group. The deleted friend may no longer be able to view the user's profile and may not be included in any hub-and-spoke arrangements generated for the user. The deleted friend may no longer be able to communicate with the user.

The user may mark certain friends in the list of friends as favorite friends. Processing circuitry 306 may automatically associate media assets that match interests of the favorite friend with the profile of the user. In some implementations, the favorite selections of the favorite friend (e.g., favorite band, favorite music, favorite movie, etc.) may be copied over to replace the user's favorite selections.

Priorities may also be assigned to certain friends or favorite friends. Processing circuitry 306 may track favorite media assets or selections made by friends with a higher priority. Processing circuitry 306 may modify the user's profile based on activities of friends with higher priorities than others. For example, when a first friend with a higher priority than a second friend changes a favorite band, processing circuitry 306 may automatically modify the user's favorite selections stored in the user profile. However, when the second friend makes a similar change, processing circuitry 306 may prompt the user about that change which the second user made and allow the user to accept or reject a change to the user's profile based on the second user's change.

Processing circuitry 306 may receive a selection of add media assets option 580. As a result, processing circuitry 306 may navigate a user to a new screen or display a window next to the option 580 that allows the user to select or browse for media assets to mark as being media assets of interest to the user. For example, a search engine may be provided for the user that allows the user to search for media assets of interest. When the user finds a media asset of interest, the user may store an identifier to the media asset in the profile that marks that media asset as a favorite. Alternatively or in addition, processing circuitry may extract characteristics of the selected media asset and recommend or provide other media assets to the user in which the user may have an interest.

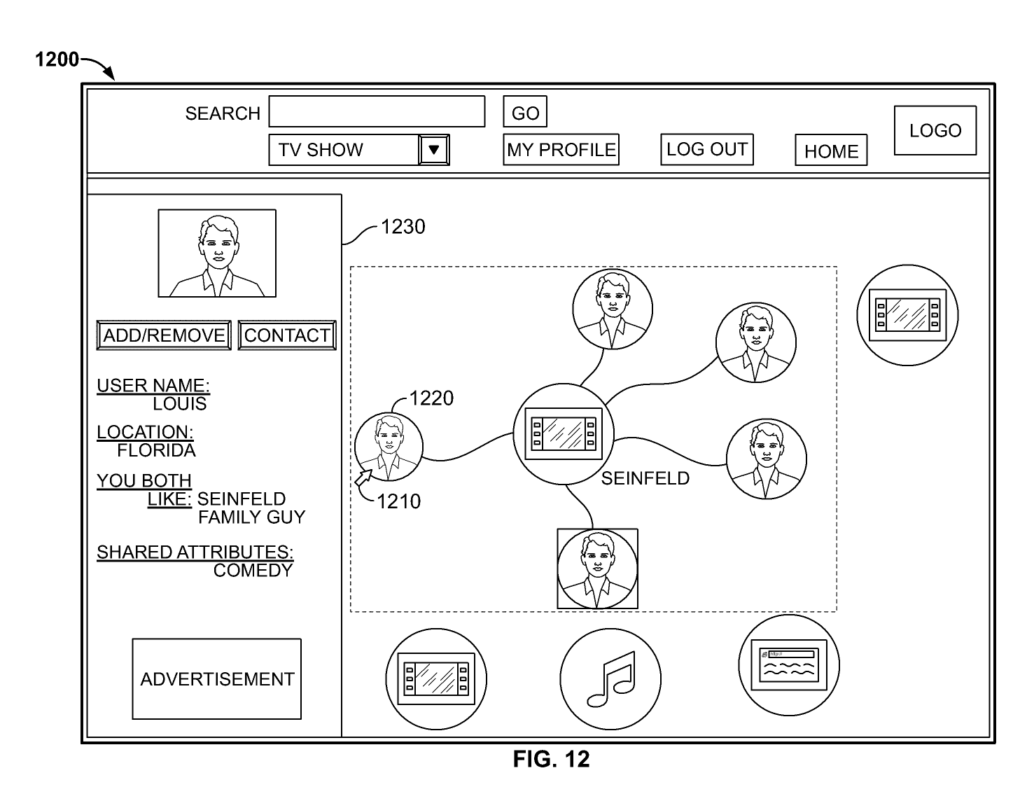

A media asset that is added by the user may be included in a hub-and-spoke arrangement. For example, a hub-and-spoke arrangement shown and described in connection with FIG. 6 may be generated in which the added media asset(s) is/are displayed as the spokes and the profile representation that includes the added media assets is displayed as the hub. In addition, a hub-and-spoke arrangement shown and described in connection with FIG. 12 may be generated in which the added media asset is displayed as the hub and the profile representation(s) that include the added media asset are displayed as the spokes.

Processing circuitry 306 may also include an interactive list of selectable media assets which the user has added when the user selects view media assets option 592. The interactive list may be displayed in a window next to option 592 or in a new window to which the user is navigated. Processing circuitry 306 may receive a selection of any one of the media assets in the interactive list to either delete the interest in the media asset, access, playback or view the media asset or view a hub-and-spoke arrangement associated with the media asset. For example, the user may access hub-and-spoke arrangements of media assets to see which other members including the user in the network have preferences that match characteristics of a selected media asset. In particular, processing circuitry 306 may bring up a display similar to the one shown in FIG. 12 that shows the selected media asset representation in the center as the hub of the hub-and-spoke arrangement and community member identifiers of community members that have preferences that match characteristics of the media asset as the spokes.

The user may also delete media assets from the list to disassociate the user's profile from the media asset. The deleted media asset may no longer be included in any hub-and-spoke arrangements generated for the user. The user may mark certain media assets in the list of media assets as favorite media assets. Processing circuitry 306 may add a link or reference to the favorite media assets to the profile of the user.

Processing circuitry 306 may receive input from the user through search textbox 520. For example, the user may provide a search string to processing circuitry 306 to use to identify other people or members or media assets. A drop-down menu 522 may be provided to allow the user to instruct processing circuitry 306 to narrow the search using certain criteria. For example, drop-down menu 522 may provide a list of criteria including, for example, TV Show, actor, director, username, first name, last name, film, band, musician, artist, album, titles, tracks, broadcast time and channel, broadcast date, any other suitable criteria or combination thereof.

Processing circuitry 306 may execute the search based on the input search string after processing circuitry 306 receives a user selection of go option 524. Processing circuitry 306 may search a local or remote database or storage device for the search string included in the criteria specified with menu 522. For example, when criteria 522 is a TV Show, processing circuitry 306 may execute the search of remote databases, local databases, storage devices or websites that relate to TV Shows having the search string matching the string provided in textbox 520. The search may return multiple results or only a single result depending on how many items match the search.

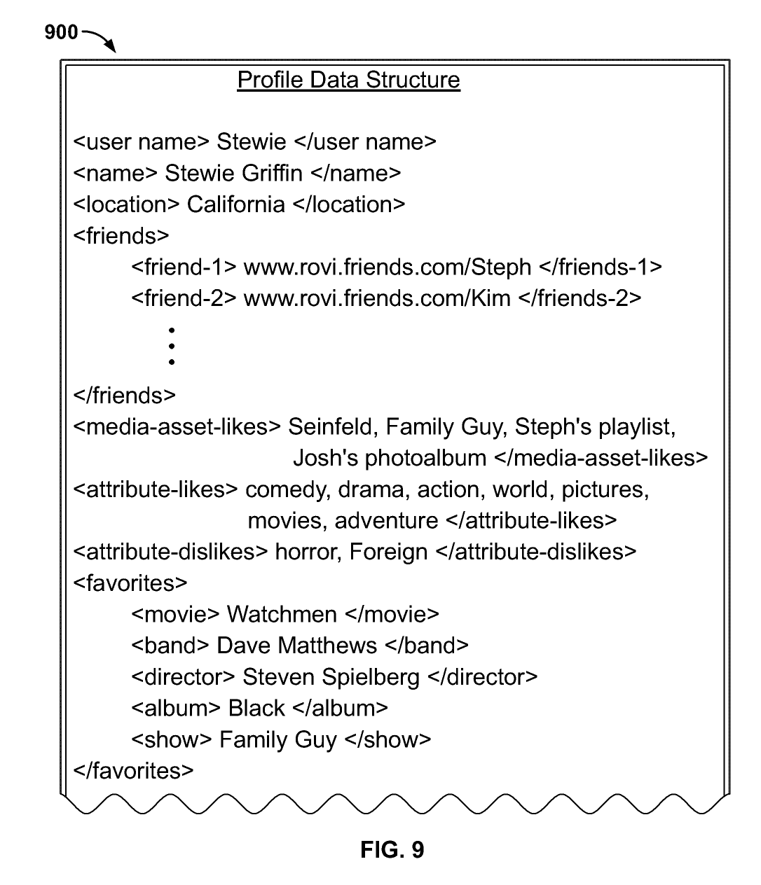

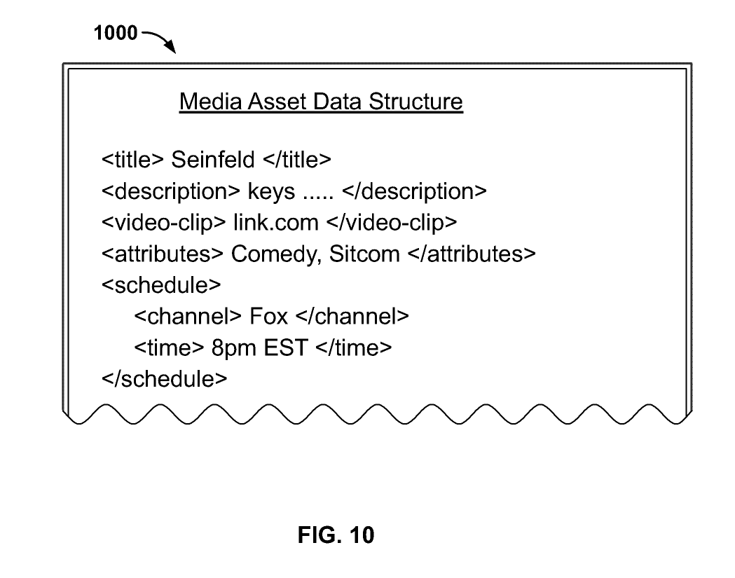

The user may also be provided with an option to limit the number of search results. When the search results are limited, processing circuitry 306 may prioritize the items that match the search string based on the closest matches and display a number of matching items less than or equal to the limit provided by the user. In some implementations, processing circuitry 306 may first search fields matching the criteria provided by the user of locally stored data structures (e.g., profile or media asset data structures 900 or 1000 (FIGS. 9 and 10)) and then when a number of items less than the limit are found, processing circuitry 306 may search remote databases. For example, when the criteria is a title, processing circuitry 306 may search titles fields of media asset data structure 1000 to determine whether the field matches the search string of textbox 520.

Processing circuitry 306 may generate a display in a window next to go option 524 or as a new screen that includes a list with the items resulting from the search. The list may be interactive such that the user may add or mark as favorite items in the list. For example, when the search yields media asset items, the user may select an add option to add a particular media asset in the interactive list to the profile and as a result to the hub-and-spoke displays associated with the user. When the search yields other users or members and/or their profile representations on the network, the user may select an add option to add the particular user or member to the list of friends associated with the user. In some implementations, the results of a search may be displayed in a hub-and-spoke arrangement. For example, an identifier of the search term provided through textbox 520 may be displayed as the hub of the hub-and-spoke arrangement and identifiers of results that match the search term may be displayed as the spokes of the hub-and-spoke arrangement.

Processing circuitry 306 may receive a user selection of edit profile option 530. As a result, processing circuitry 306 may generate a screen that allows the user to view or change various settings of the preference profile associated with the user. For example, the user may change which media assets or friends are marked as favorite. The user may also change which attributes the user likes or dislikes about various media assets.

In some implementations, the preference profile may be generated automatically or created manually by the user (e.g., by accessing edit profile option 530). For example, the profile may be generated by processing circuitry 306 by asking a user questions in the form of a survey relating to the user's likes and dislikes. More specifically, the system may ask a user whether he/she likes or dislikes particular media assets. Based on the responses of the user, the profile may be generated and stored. The profile may be stored locally or remotely on a server. Additionally or alternatively, the profile may be stored on another user device inside or outside of the user's home.

Each preference profile may include preferences a member or user in the community has for accessing a particular media asset. In some implementations, media assets may be any video, audio, document, game, Internet delivered program, television program, on-demand program, pay-per-view program, audio book, on-demand video or audio content, playlist of video and/or audio content, link to a playlist of video and/or audio content, or other suitable item which a user can perceive and/or interact with. The preference profile is used by processing circuitry 306 to determine media assets in which a particular user may have an interest.

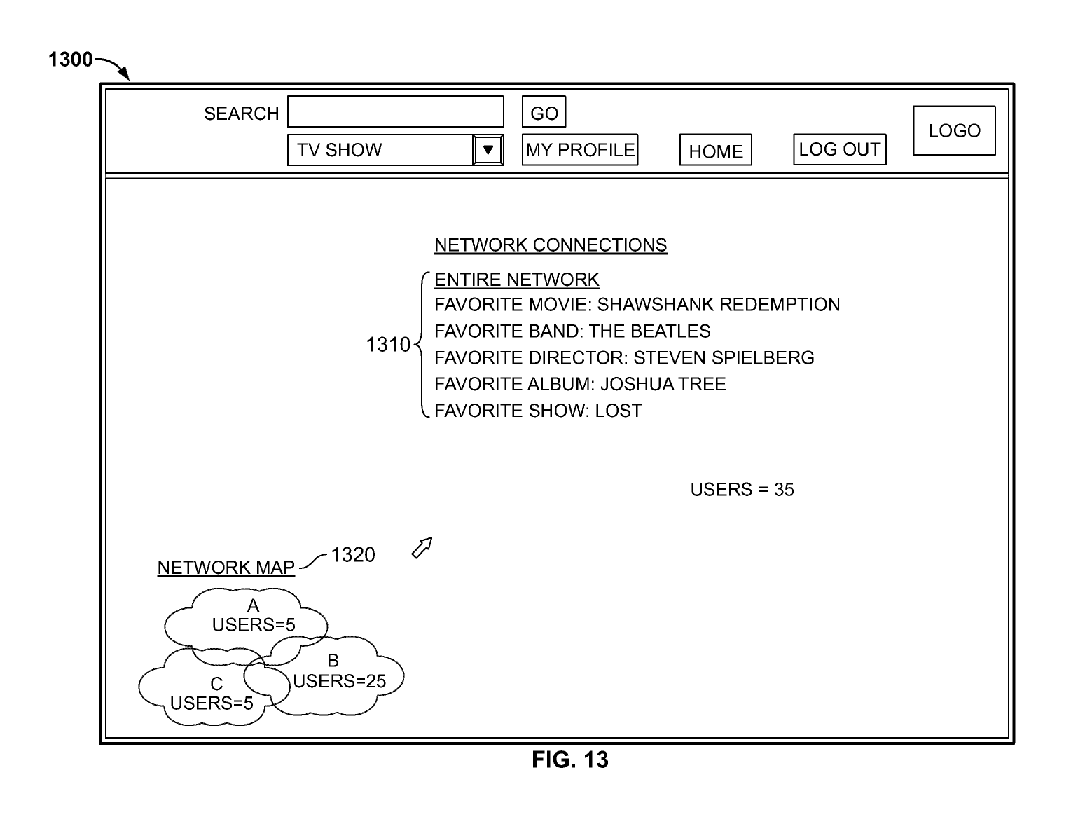

Processing circuitry 306 may receive a user selection of network connections option 560. As a result, processing circuitry 306 may generate a display screen 1300 (FIG. 13) of preferences relating to the community or other members as a whole (e.g., the favorite item amongst all the users within the user's community) discussed in more detail below.

Processing circuitry 306 may receive a user selection of access hub-and-spoke option 550. As a result, processing circuitry 306 may generate a display screen 600 (FIG. 6) of the media assets which match the user's interests in a profile hub-and-spoke arrangement. The user profile hub-and-spoke arrangement may include a profile representation of the user as the hub and media asset representations of media assets that match interests of the user as the spokes around the hub. The hub-and-spoke arrangement may be interactive to allow the user to get more information about various media assets and to access media asset hub-and-spoke arrangements of displayed media asset representations.

FIG. 6 shows an illustrative display 600 of a hub-and-spoke arrangement associated with a particular user in accordance with an embodiment of the invention. Display 600 may be the screen presented to the user immediately after the user successfully logs into the network or community using a computer connected to the Internet or intranet or other suitable device or terminal (e.g., set top box). Display 600 may include a profile hub and spoke arrangement 610 and a user identifier region 670. User identifier region 670 may include user profile representation 660 which visually identifies the user to which profile hub-and-spoke arrangement 610 corresponds.

User profile representation 660 may include an icon, image, video, animation, sound or any other suitable identifier that is tailored to the user. In particular, user profile representation 660 may be any suitable identifier that the user perceives and associates with himself or another community member. For example, user profile representation 660 may be a picture of the user to which the user preference profile corresponds or may be the same as profile representation 510 (FIG. 5). In some embodiments, after the user logs into the network or community, screen 600 may be displayed and user identifier region 670 may correspond to the user who just logged into the system. The user may select or search for various other community members on the network or community and as a result, user identifier region 670 may change to correspond to the selected or searched for other community member.

User identifier region 670 may include an information region that includes information associated with the user that is being viewed corresponding to user profile representation 660. The information region may be populated based on some or all of the information included in profile data structure 900 (FIG. 9) associated with the community member. For example, each community member may have his/her own profile data structure stored in the system. When screen 600 is generated, processing circuitry 306 may retrieve data from fields within profile data structure corresponding to the user or community member and generate a display which includes in the information region of user identifier region 670 the retrieved data.

In some embodiments, the information region may include the username of the user or community member which may be any number, character or alphanumeric representation unique to the user. The username may be the textual identifier of the user which other community members in the community use to identify the user. For example, when other members or users of the community would like to contact the particular user, the other members may need to only provide the username of the user. Processing circuitry 306 may search for the profile data structure 900 corresponding to the selected username and retrieve data (e.g., an email address or IP address) associated with that username to allow the members to communicate (e.g., via email, text message, telephone, cell phone or instant message). As discussed above, the username may be used by a user to initially log into the network or community.

User identifier region 670 may include a contact option 664. When processing circuitry 306 receives a user selection of contact option 664, processing circuitry 306 may retrieve contact information associated with the user corresponding to user identifier region 670 from a profile data structure 900 associated with the user. For example, processing circuitry 306 may retrieve a phone number of the user associated with information region 670 and provide that phone number or automatically dial that phone number when the user selects contact option 664. Alternatively or in addition, processing circuitry 306 may retrieve an email address of the user associated with information region 670 and provide an email message screen that allows a user to type an email to the retrieved email address when the user selects contact option 664.

User identifier region 670 may include a profile option 662. When processing circuitry 306 receives a user selection of profile option 662, processing circuitry 306 may retrieve information corresponding to user identifier region 670 from a profile data structure 900 (FIG. 9) associated with the user. The retrieved information may include attributes, favorite media assets, and friend lists or favorite friends associated with the user corresponding to the profile data structure 900. For example, the retrieved information may include a list of the likes/dislikes associated with the user. Processing circuitry 306 may generate a display that includes the retrieved information. The user may select from the display of the retrieved information media asset identifiers, friend identifiers or attributes which the user would like to add to his/her own profile. For example, when the retrieved information associated with a first user includes an attribute indicating a like for action type media assets, selection of that attribute may add that particular attribute (e.g., a like for action type media assets) to the profile data structure 900 associated with the second user that is viewing that retrieved information.

The Information region may include the name of the user that is associated with the username and profile representation 660. In some implementations, The name of the user may be visible only to the user at the device that corresponds to the user identifier region 670. For example, when the user Stewie accesses user identifier region 670 that corresponds to his preference profile, his full name may be visible (e.g., Stewie Griffin). However, when the user Stewie accesses Brian's user identifier region 670, only Brian's username may be visible to Stewie and not Brian's full name. In other implementations, the user may choose to make the full name public to the community thereby allowing other members to identify the user my username, user identifier and/or full name.

Additional information that may be displayed in the information region may include the name of the community to which the user belongs, a branch of the community, or any other information that informs a user or community member about the communities to which the user or community member corresponding to user identifier region 670 belongs. In particular, when the user is part of a community which is a company, the name of the company may be displayed as well as the office location (if multiple office locations exist in the company). For example, when the user is an employee of the Rovi Corporation, the name of the corporation may be displayed. Additionally, if Rovi Corporation has offices around the world, and the user is employed in the New York office, processing circuitry 306 may include that information in the information region.

Display 600 may include a community identifier 690 which may uniquely identify the community or communities to which the user belongs. For example, when the user is a member of a community which is a company, the logo of the company may be displayed as community identifier 690. An advertisement may be displayed which may be targeted to the user based on the user's profile or may be sponsors of the community. For example, the community may be provided to users by a free service which generates revenue by providing advertisements of sponsors. The advertisements may be videos, images, or animations. Additionally, when the user selects a displayed advertisement, the user may be navigated to a website of the sponsor associated with the advertisement. Alternatively, the user may be provided with an option to purchase an item (e.g., video, product, book, etc.) or schedule a recording, order a program, tune to the show, or subscribe to a service that is being advertised when the user selects the corresponding advertisement.

Processing circuitry 306 may generate for display profile hub-and-spoke arrangement 610 which may include a user identifier 620, links 640 and 642 and media asset identifiers 630. Community member identifiers 650 may also be displayed within profile hub-and-spoke arrangement 610 or outside profile hub-and-spoke arrangement 610. It should be understood, that community member identifiers correspond to other users or members of the community or network. Media asset identifiers 630 may represent any type of media including photographs, photo albums, music albums, directors, movies, media asset playlists, audio assets, video assets, websites, links to websites, or any other type of accessible content or combination thereof. Media asset identifiers 630 may be icons, video clips, audio clips, live video, real-time audio, website images, or any combination thereof that can be used to represent the media assets. User identifier 620 may be a video, audio, icon or any other suitable representation of the user. In some implementations, user identifier 620 may be unique to the user amongst the community members.

Profile hub-and-spoke arrangement 610 allows the user to visually identify media assets that match characteristics of the profile corresponding to user identifier 620. User identifier 620 may correspond to the information provided in user identifier region 670. In particular, user identifier 620 may correspond to the same user as user identifier region 670. User identifier 620 may be the same or a smaller or larger version of profile representation 660.

The user may also visually identify other members of the community that share at least one characteristic with the user (e.g., other members that are friends with the user). In some embodiments, the community member identifiers 650 may be hidden from display such that the user only sees media asset identifiers 630 that correspond to media assets that match characteristics of the user's profile in profile hub and spoke arrangement 610. Community member identifiers 650 may be a video, audio, icon or any other suitable representation associated with each other community member. In some implementations, community member identifiers 650 may be unique to each community member amongst the community or network.

User identifier 620 may be positioned substantially in the center of profile hub-and-spoke arrangement 610 while media asset identifiers 630 and community member identifiers 650 may be positioned substantially around user identifier 620. It should be understood that media asset identifiers 630 and community member identifiers 650 may be positioned in a substantially circular manner around user identifier 620 or in random positions about user identifier 620. Media asset identifiers 630 and/or community member identifiers 650 may dynamically move around in a circular manner around user identifier 620. For example, media asset identifiers 630 and/or community member identifiers 650 may circulate, revolve or rotate around user identifier 620 in a clockwise or counterclockwise manner such that they are repositioned once every second or any other suitable time or speed.

In some embodiments, the distance between each media asset identifier 630 and user identifier 620 may reflect the relative match between the attributes stored in the user's profile and the characteristics of the media asset(s) corresponding to the media asset identifier(s) 630. For example, the closer in proximity a first media asset identifier 630 is to user identifier 620 than a second media asset identifier 630, the more similar the characteristics of a first media asset corresponding to the first media asset identifier are to the preferences of the profile corresponding to user identifier 620. In particular, a first media asset identifier 630 may correspond to a media asset having media asset data structure 1000 (FIG. 10) with comedy and action characteristics while a second media asset identifier 630 may correspond to a media asset having media asset data structure 1000 (FIG. 10) with comedy and drama characteristics. A profile data structure 900 (FIG. 9) associated with user identifier 620 may indicate that comedy and action attributes are liked and that drama attribute is not liked. Accordingly, the distance between the first media asset identifier 630 and user identifier 620 may be shorter than the distance between the second media asset identifier 630 and user identifier 620 since the first media asset identifier 630 corresponds to a media asset which has characteristics that match more attributes of the user profile data structure 900.

In some implementations, processing circuitry 306 may determine how relevant one media asset corresponding to a media asset identifier 630 is to the user corresponding to user identifier 620 by measuring a Euclidean distance. For example, processing circuitry 306 may compute a Euclidean distance between (1) the profile data structure 900 attributes and preferences associated with the user corresponding to user identifier 620 and (2) media asset characteristics defined in a media asset data structure 1000 (FIG. 10) that correspond to media asset identifier 630. The Euclidean distance may be stored locally or remotely to a memory for each media asset identifier 630 that is displayed. Based on the Euclidean distance processing circuitry 306 may determine how close or how far away from user identifier 620 to display a given media asset identifier 630. An illustrative Euclidean distance-based approach is described in U.S. patent application Ser. No. 11/324,147, filed Dec. 29, 2005, incorporated by reference herein in its entirety.

In some embodiments, the distance between a first of media asset identifiers 630 and a second of media asset identifiers 630 that is adjacent to the first media asset identifier may indicate a similarity between characteristics of the first and second media assets corresponding to the first and second media asset identifiers. For example, the closer in proximity the first and second media asset identifiers 630 are to each other, the more similar the characteristics of the media asset data structures 1000 (FIG. 10) corresponding to those media asset identifiers. Processing circuitry 306 may compute a Euclidean distance computation between each of the media asset data structures 1000 corresponding to each of the media asset identifiers 630 to determine how far/close to display each of the identifiers 630 relative to each other.

In some embodiments, the distance between each one of community member identifiers 650 and user identifier 620 may reflect the relative similarity between the attributes of the profile data structure corresponding to the community member and the profile data structure corresponding to the user identifier 620. For examples, a community member having a profile data structure with more likes/dislikes that are similar to the profile data structure corresponding to user identifier 620 may have a community member identifier 650 displayed closer to user identifier 620 than another community member identifier 650. More specifically, the more similarities that exist between the profile associated with a community member and the user's profile the closer that community members' identifier 650 may be positioned to user identifier 620.

In some implementations, processing circuitry 306 may determine how similar one of the profile data structures 900 corresponding to a community member identifier 650 is to the user corresponding to user identifier 620 by measuring a Euclidean distance. For example, processing circuitry 306 may compute a Euclidean distance between (1) the profile data structure 900 attributes and preferences associated with the user corresponding to user identifier 620 and (2) the profile data structure 900 attributes and preferences associated with the member corresponding to community member identifier 650. The Euclidean distance may be stored locally or remotely to a memory for each community member identifier 650. Based on the Euclidean distance processing circuitry 306 may determine how close or how far away from user identifier 620 to display a given community member identifier 650.

In some implementations, the distance between each one of community member identifiers 650 and user identifier 620 may reflect how long the user corresponding to the user identifier 620 has known or been friends with the community member associated with the community member identifier 650. For example, if the user has known or been friends with a first member longer than a second, the first member which the user has known longer may have a community member identifier 650 displayed closer to user identifier 620 than community member identifier 650 corresponding to the second member. To keep track of how long a user has known or been friends with a particular community member, processing circuitry 306 may store a time stamp and username in the profile data structure 900 associated with user identifier 620 with the time and date of when the user added the community member to the user's friend list.

In some embodiments, the distance between a first community member identifier 650 and a second community member identifier 650 that is adjacent to the first community member identifier may indicate a similarity between attributes of the first and second community member profiles corresponding to the first and second community member identifiers. For example, the closer in proximity the first and second community member identifiers 650 are to each other, the more similar the attributes of the profile data structures 900 (FIG. 9) corresponding to those community member identifiers.

The hub (e.g., user identifier 620) and each spoke (e.g., media asset identifier 630) may connected by links 640 and 642. Different links 640 and 642 may be used to represent different connection types to media asset identifier 630. For example, link 640 may be a solid line while link 642 may be a dashed line. Also, different colors may be used to indicate different connection types. Additionally, colors and types of lines (e.g., solid or dashed) may be used in combination to indicate a variety of different connections or similarities.

In some implementations, a dashed line may indicate that the media asset corresponding to the media asset identifier 630 may be a recommended media asset. In some implementations, a solid line may indicate that the media asset corresponding to the media asset identifier 630 may be a media asset that the user has added. Alternatively, a dashed line may indicate that the media asset corresponding to the media asset identifier 630 may be new to the user in that the user has not accessed that media asset before. Alternatively, a dashed line may indicate that the media asset corresponding to the media asset identifier 630 may be old to the user in that the user has previously accessed that media asset. Alternatively, a dashed line may indicate which attribute of the profile data structure corresponding to user identifier 620 matches the characteristics of media asset data structure 1000 corresponding to media asset identifier 630. For example, a dashed line may indicate that the comedy attribute matches the characteristics of the media asset while a solid line may indicate that the action attribute matches the characteristics of a media asset. The user may position a cursor over any one of the links to determine what the link represents. In some implementations, processing circuitry 306 may display a list of items that match the preferences of the user which caused the media asset identifier 630 to be displayed when the user positions a cursor over a particular link.

Search related fields 520, 522 and 524 (FIG. 5) may be displayed in screen 600 and any other screen discussed above and below and may be used to perform searches as discussed in connection with FIG. 5. The user may select an option to hide the search related fields to avoid cluttering the display screen. When the user desires to search, the user may select an option to make the search related fields re-appear on the display. Using setup options 540, the user may configure in which screens and at what times processing circuitry 306 should display the search related fields. In some implementations, the user may select an option in setup options 540 to never display search related fields in certain display screens.

When the user positions a cursor over one of media asset identifiers 630 or one of community member identifiers 650, processing circuitry 306 may automatically display information about the media asset corresponding to media asset identifier 630 or the community member corresponding to community member identifier 650 over which the cursor is positioned. For example, when the user positions a cursor over one of the media asset identifiers 630, processing circuitry 306 may display a window next to the media asset identifier 630 over which the cursor is positioned that includes information about the media asset corresponding to the media asset identifier 630. In some implementations, instead of or in addition to displaying the information in a window, the information about the media asset may be provided in place of or within user identifier region 670.

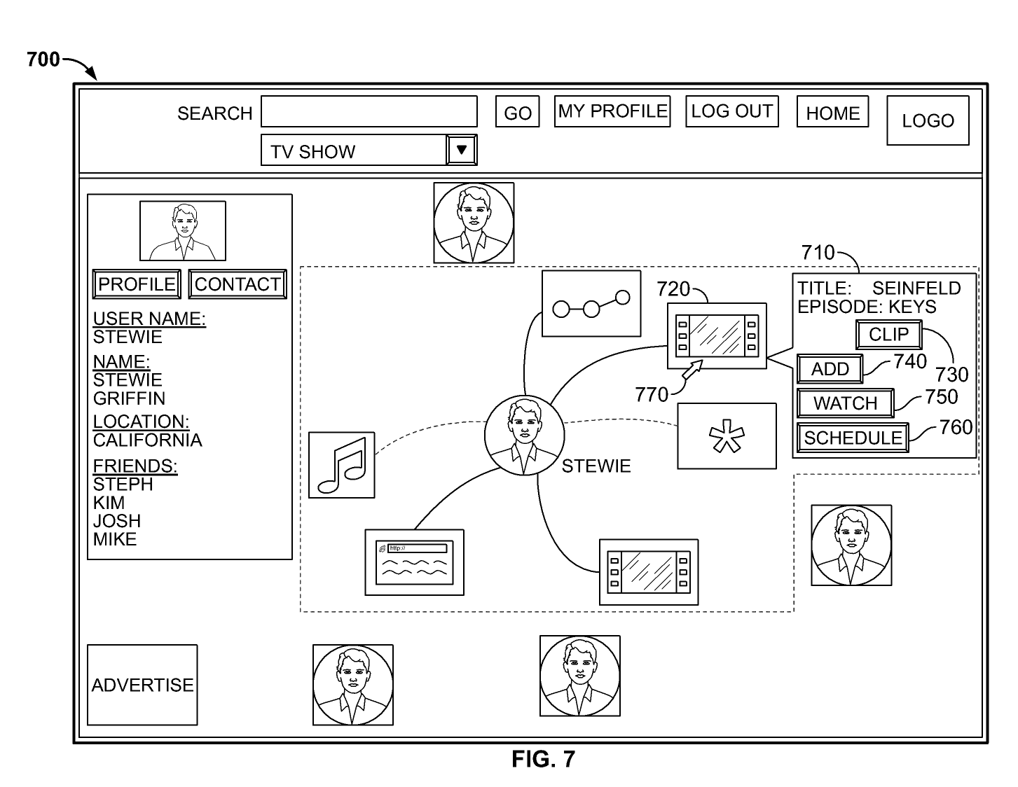

FIG. 7 is an illustrative display screen 700 of a window 710 providing information about a media asset corresponding to a media asset identifier 720 in accordance with an embodiment of the invention. For example, a cursor 770 may be positioned over media asset identifier 720. As a result, without user input, processing circuitry 306 may automatically display window 710 that includes information about the media asset corresponding to media asset identifier 720. In particular, processing circuitry 306 may retrieve a media asset data structure 1000 corresponding to media asset identifier 720 and generate a window that includes some or all of the information from the retrieved media asset data structure.

Window 710 may include a title of the media asset corresponding to media asset identifier 720, a short description of the media asset and various options. For example, window 710 may include clip option 730, add option 740, watch option 750 and schedule option 760. Processing circuitry 306 may receive a selection of watch option 750 and as a result processing circuitry 306 may tune to, download or otherwise access the media asset corresponding to media asset identifier 720. In some implementations, processing circuitry 306 may determine that the media asset corresponding to media asset identifier 720 is in the middle of being broadcast and may provide the user with the option to startover when the user selects watch option 750. In particular, selection of option to startover may instruct processing circuitry 306 to retrieve a stored version of the media asset being broadcast to allow the user to view the media asset corresponding to media asset identifier 720 from the beginning instead of being forced to start watching from somewhere in the middle of the media asset.

Processing circuitry 306 may receive a selection of clip option 730. As a result, processing circuitry 306 may retrieve a video clip of the media asset corresponding to media asset identifier 720. Processing circuitry 306 may display the retrieved video clip in place of window 710, next to window 710 or in a new screen. When the video clip ends, processing circuitry 306 may return the user to display screen 700 where window 710 is provided.

Processing circuitry 306 may receive a selection of schedule option 760. As a result, processing circuitry 306 may schedule the media asset corresponding to media asset identifier 720 for recording or alternatively schedule a reminder for the media asset. The media asset may be scheduled for recording locally on the computer used to access the community or network or may be scheduled for recording at another location (e.g., where a recording device associated with the user is located). For example, the computer may not be capable of recording the media asset and accordingly processing circuitry 306 may cause the user's set top terminal to schedule the media asset for recording. Processing circuitry 306 may instruct the set top terminal directly over the Internet or through a third party server such as a television cable or satellite service provider.

Processing circuitry 306 may receive a selection of add option 740. As a result, processing circuitry 306 may add the media asset corresponding to media asset identifier 720 to the user's profile. In particular, processing circuitry 306 may execute a similar function as the function discussed above in connection with option 580 (FIG. 5).

Referring back to FIG. 6, when the user positions a cursor over one of the community member identifiers 650, processing circuitry 306 may display a window next to the community member identifier 650 over which the cursor is positioned that includes information about the community member corresponding to the community member identifier 650. In some implementations, instead of or in addition to displaying the information in a window, the information about the community member may be provided in place of or within user identifier region 670.

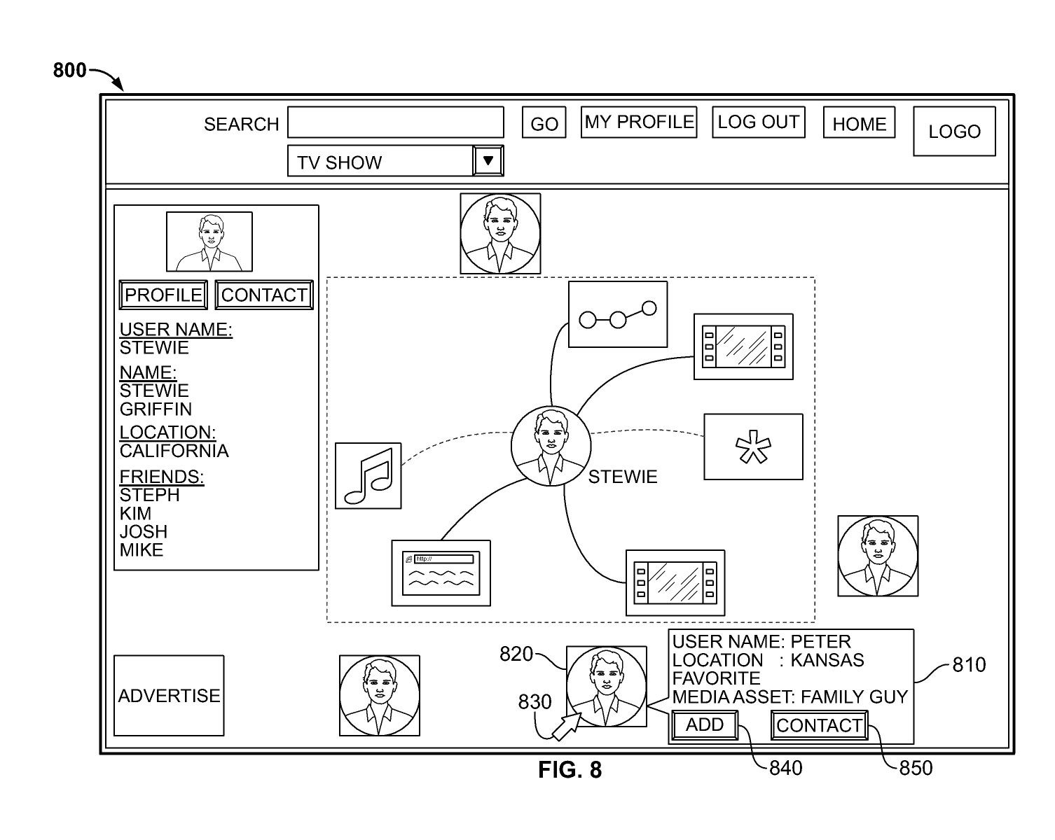

FIG. 8 is an illustrative display screen 800 of a window 810 providing information about a community member corresponding to a community member identifier 820 in accordance with an embodiment of the invention. For example, a cursor 830 may be positioned over community member identifier 820. As a result, without user input, processing circuitry 306 may automatically display window 810 that includes information about the community member corresponding to community member identifier 820. In particular, processing circuitry 306 may retrieve a profile data structure 900 corresponding to community member identifier 820 and generate a window that includes some or all of the information from the retrieved profile data structure.

Window 810 may include a username of the community member corresponding to community member identifier 820, a full name, a location within the community or network, favorite content, other relevant information from the profile corresponding to the community member and various options. For example, window 810 may include add option 840 and contact option 850. Processing circuitry 306 may receive a selection of add option 840. As a result, processing circuitry 306 may add the community member corresponding to community member identifier 820 to the user's friend list. In particular, processing circuitry 306 may execute a similar function as the function discussed above in connection with option 570 (FIG. 5).

Processing circuitry 306 may receive a selection of contact option 850. As a result, processing circuitry 306 may allow the user to communicate with the community member corresponding to community member identifier 820. In particular, processing circuitry 306 may execute a similar function as the function discussed above in connection with option 664 (FIG. 6).

In some implementations, the community member associated with community member identifier 820 may be presently logged into the network or community at the time cursor 830 is positioned over community member identifier 820. In such circumstances, the user may be given the option to instantly communicate with the community member through window 810. For example, processing circuitry 306 may have a list of users active within the community (e.g., members who are logged in presently to the community) and generate a chat session within window 810 when the community member corresponding to community member identifier 820 is logged in. In particular, processing circuitry 306 may provide a text box (not shown) within window 810 through which the user may type messages and receive messages to/from the community member corresponding to community member identifier 830.

In some embodiments, a similar text box may be generated and provided within window 810 for a community member corresponding to community member identifier 820 who is not logged in. In such circumstances, processing circuitry 306 may transmit the message provided through the text box to as a text message or multimedia message directly to a cell phone or other suitable mobile device associated with the particular member. In some implementations, instead of allowing the users to communicate via text or multimedia messages through window 810, processing circuitry 306 may send an email message with the data provided through a text box within window 810 to the corresponding community member.

Referring back to FIG. 6, when the user selects a particular community member identifier 650 (e.g., by positioning a cursor and pressing a suitable button or key over the desired community member identifier 650), processing circuitry 306 may generate a display screen 600 associated with the preferences of a profile associated with the selected community member. For example, processing circuitry 306 may generate for display a hub-and-spoke arrangement tailored to the selected community member. More specifically, the hub-and-spoke arrangement may include a visual representation (e.g., icon, video, photograph or any other visual representation) of the selected community member as the hub within the hub-and-spoke arrangement. Processing circuitry 306 may determine which media assets have characteristics that match attributes within the profile associated with the selected community member. Processing circuitry 306 may include as the spokes of the hub-and-spoke arrangement, visual representations of the media assets that have characteristics that match attributes of the profile associated with the selected community member.

The distances between each of the items displayed within the hub-and-spoke arrangement may be selected and set based on the same or similar criteria as discussed above in connection with hub-and-spoke arrangement 610 associated with the user. As discussed above, community member identifiers 650 identifying friends of the selected community member may also be generated for display about the hub-and-spoke arrangement associated with the selected community member. In some implementations, whenever a community member hub-and-spoke arrangement is generated for display, corresponding community member identification information may be displayed in place of user identifier region 670. The information associated with the selected community member may include the same or similar information that is shown and described in connection with user identifier region 670. The information may be retrieved from a stored corresponding profile data structure 900 associated with the selected community member.

User identifier region 670 may also include information identifying assets that may match attributes of both the user viewing the screen and navigating the network and the selected community member. In particular, user identifier region 670 may include a section identified as “media assets you both like” which may list all the media assets that have characteristics that match attributes of both the user and the community member profiles. These same media assets may include corresponding media asset identifiers 630 displayed as the spokes for the hub-and-spoke arrangements associated with the user and the hub-and-spoke arrangements associated with the community member.

In some implementations, the user may select one of the community member identifiers associated with the selected community member hub-and-spoke arrangement to cause another hub-and-spoke arrangement tailored to the selected community member to be generated and displayed. Such navigation techniques allows the user to see and interact with other members of the community. In particular, the user is given the opportunity to see what media assets other members of the community like and dislike and to also see with whom other members of the community are friends.

In some embodiments, processing circuitry 306 may receive a user selection of one of media asset identifiers 630 and an interactive media asset hub-and-spoke arrangement may be provided. The interactive media asset hub-and-spoke arrangement may visually identify community members that have profiles with attributes that match characteristics of a media asset. The user may navigate through the media asset hub-and-spoke arrangement to select various community members for which to view an associated hub-and-spoke arrangement.

FIG. 11 shows an illustrative display 1100 of a hub-and-spoke arrangement associated with a particular media asset in accordance with an embodiment of the invention. Display 1100 may include a media asset hub and spoke arrangement 1110 and a media asset identifier region 1130. Media asset identifier region 1130 may include media asset representation 1132 which visually identifies the media asset to which hub-and-spoke arrangement 1110 corresponds.

Media asset representation 1132 may include an icon, image, video, animation, sound or any other suitable identifier that is tailored to the media asset. In particular, media asset representation 1132 may be any suitable visual identifier that the user perceives and associates with a corresponding media asset. For example, media asset representation 1132 may be a picture of the album cover of a movie corresponding the media asset. In some embodiments, after the user selects a particular media asset identifier 630 (FIG. 6), display 1100 may be provided and media asset identifier region 1130 may correspond to the media asset that is associated with the selected media asset identifier. The user may select or search for various other media assets and as a result, media asset identifier region 1130 may change to correspond to the selected or searched for media asset.

Media asset identifier region 1130 may include an information region that includes information associated with the media asset that is being viewed corresponding to media asset representation 1132. The information region may be populated based on some or all of the information included in media asset data structure 1000 (FIG. 10) associated with the media asset. For example, each media asset may have its own media asset data structure stored in the system. When screen 1100 is generated, processing circuitry 306 may retrieve data from fields within media asset data structure corresponding to the media asset and generate a display which includes in the information region of media asset identifier region 1130 the retrieved data.

In some embodiments, the information region may include the title of the media asset which may be any number, character or alphanumeric representation unique to the media asset and a short description of the media asset. Information region may also include a list of attributes of a user profiles that match characteristics of the media asset.

Media asset identifier region 1130 may include a more information option 1150. When processing circuitry 306 receives a user selection of more information option 1150, processing circuitry 306 may retrieve information corresponding to media asset identifier region 1130 from a media asset data structure 1000 (FIG. 10) associated with the media asset. The retrieved information may include characteristics of the media asset, airtimes, links to access the media asset, genre, related media assets, detailed information, and/or data pertaining to a video or audio clip of the media asset. Processing circuitry 306 may generate a display that includes the retrieved information. The user may select from the display of the retrieved information, media asset identifiers, or characteristics which the user would like to add to his/her own profile. For example, when the retrieved information associated with the media asset includes an action characteristic, selection of that characteristic may add an action attribute (e.g., a like for action type media assets) to the profile data structure 900 associated with the user that is viewing that retrieved information.

Media asset identifier region 1130 may include an add/remove option 1140. When processing circuitry 306 receives a user selection of add/remove option 1140, processing circuitry 306 may add to a profile data structure associated with the user an identifier indicating a like for the media asset or indicating that the media asset is a favorite. Selection of add/remove option 1140 may provide the same or similar functionality as selection of add media assets option 580. When the profile data structure already includes an identifier associated with the particular media asset, processing circuitry 306 may remove that identifier from the profile when processing circuitry 306 receives a selection of add/remove option 1140. In some implementations, processing circuitry 306 may request, by way of a prompt or window, that the user confirm the desire to remove the identifier of the media asset and/or attributes associated with the media asset from the profile of the user.

Processing circuitry 306 may generate for display media asset hub-and-spoke arrangement 1110 which may include a media asset identifier 1112, links 1114 and community member identifiers 1116. Related media asset identifiers 1120 and 1122 may also be displayed within media asset hub-and-spoke arrangement 1110 or outside media asset hub-and-spoke arrangement 1110. Media asset identifier 1112 may be the same or similar as media asset identifier 630 (FIG. 6). In some implementations, media asset identifier 1112 may be an image, a video, an animation, an audio message, a clip of the show corresponding to the media asset, or a channel currently airing or playing back the particular media asset corresponding to media asset identifier 1112.

Media asset hub-and-spoke arrangement 1110 allows the user to visually identify members of the community that have profile attributes that match characteristics of the media asset corresponding to media asset identifier 1112. Media asset identifier 1112 may correspond to the information provided in media asset identifier region 1130. In particular, media asset identifier 1112 may correspond to the same media asset as media asset identifier region 1130. Media asset identifier 1112 may be the same or a smaller or larger version of media asset representation 1132.

The user may also visually identify other media assets that share at least one characteristic with the media asset being viewed. In some embodiments, related media asset identifiers 1120 and 1122 may be hidden from display such that the user only sees community member identifiers 1116 that correspond to community members with profiles that match attributes of the media asset in media asset hub and spoke arrangement 1110. Related media asset identifiers 1120 and 1122 may be a video, audio, icon or any other suitable representation associated with each related media asset. In some implementations, processing circuitry 306 may identify which media assets are related to the media asset corresponding to media asset identifier 1112 based on information in media asset data structure 1000 of the media asset. In particular, media asset data structure 1000 associated with the media asset corresponding to media asset identifier 1112 may include a field that includes a list of related media assets.

Media asset identifier 1112 may be positioned substantially in the center of media asset hub-and-spoke arrangement 1110 while community member identifiers 1116 and related media asset identifiers 1120 and 1122 may be positioned substantially around media asset identifier 1112. It should be understood that related media asset identifiers 1120 and 1122 and community member identifiers 1116 may be positioned in a substantially circular manner around media asset identifier 1112 or in random positions about media asset identifier 1112. Related media asset identifiers 1120 and 1122 and/or community member identifiers 1116 may dynamically move in a circular manner around media asset identifier 1112. For example, related media asset identifiers 1120 and 1122 and/or community member identifiers 1116 may circulate, revolve or rotate around media asset identifier 1112 in a clockwise or counterclockwise manner such that they are repositioned once every second or any other suitable time or speed.

In some embodiments, the distance between each community member identifier 1116 and media asset identifier 1112 may reflect the relative match between the characteristics stored in the media asset's profile and the attributes of the community members' profiles corresponding to the community members identifier 1116. For example, the closer in proximity a first community profile identifier 1116 is to media asset identifier 1112 than a second community member identifier 630, the more similar the attributes of a first profile corresponding to the first community member identifier are to the characteristics of the media asset corresponding to media asset identifier 1112. In particular, a first community member identifier 1116 may correspond to a community member profile having profile data structure 900 (FIG. 9) with attributes identifying comedy and action as likes while a second community member identifier 1118 may correspond to a community member profile having profile data structure 900 (FIG. 9) with likes for comedy and drama characteristics. A media asset data structure 1000 (FIG. 10) associated with media asset identifier 1112 may indicate that the corresponding media asset has comedy and action characteristics. Accordingly, the distance between the first community member identifier 1116 and media asset identifier 1112 may be shorter than the distance between the second community member identifier 1118 and media asset identifier 1112 since the first community member identifier 1116 corresponds to a community member profile which has attributes that match more characteristics of media asset data structure 900 associated with the media asset.

In some implementations, processing circuitry 306 may determine how relevant the media asset corresponding to media asset identifier 1112 is to a community member corresponding to community member identifier 1116 by using by measuring a Euclidean distance in a similar manner as discussed above in connection with FIG. 6. Based on the Euclidean distance processing circuitry 306 may determine how close or how far away from media asset identifier 1112 to display a given community member identifier 1116.

In some embodiments, the distance between a first of community member identifiers 1116 and a second of community member identifiers 1116 that is adjacent to the first community member identifier may indicate a similarity between attributes of the first and second community member profiles corresponding to the first and second community member identifiers. For example, the closer in proximity the first and second community member identifiers 1116 are to each other, the more similar the attributes of the profile data structures 900 (FIG. 9) corresponding to those community member identifiers. Processing circuitry 306 may compute a Euclidean distance between each of the profile data structures 900 corresponding to each of the community member identifiers 1116 to determine how far/close to display each of the community member identifiers 1116 relative to each other.

In some embodiments, the distance between each one of related media asset identifiers 1120 and 1122 and media asset identifier 1112 may reflect the relative similarity between the characteristics of the media asset data structures corresponding to the media asset identifier 1112 and related media asset identifiers 1120 and 1122. For examples, a related media asset having a media asset data structure with more characteristics that are similar to the media asset data structure corresponding to media asset identifier 1112 may have a related media asset identifier 1122 displayed closer to media asset identifier 1112 than another related media asset identifier 1120. More specifically, the more similarities that exist between the media asset data structure associated with a related media asset and the media asset's data structure the closer that related media asset's identifier 1122 may be positioned to media asset identifier 1112. In some implementations, processing circuitry 306 may determine how similar one of the media asset data structures 1000 corresponding to a related media asset identifier 1122 is to the media asset data structure corresponding to media asset identifier 1112 by using by measuring a Euclidean distance, as discussed above in connection with FIG. 6.

In some embodiments, the distance between a first related media asset identifier 1120 and a second related media asset identifier 1122 that is adjacent to first related media asset identifier 1120 may indicate a similarity between characteristics of the first and second media assets corresponding to the first and second related media asset identifiers 1120 and 1122. For example, the closer in proximity the first and second related media asset identifiers 1120 and 1122 are to each other, the more similar the characteristics of the media asset data structures 1000 (FIG. 10) corresponding to those related media asset identifiers.

In some embodiments, the user that is viewing display 1100 and accessing hub-and-spoke arrangement 1110 may be included in media asset hub-and-spoke arrangement 1110. For example, when the user has a corresponding profile with attributes that match characteristics of the media asset corresponding to media asset identifier 1112, a community member identifier 1118 that identifies the user may be included as one of the spokes in hub-and-spoke arrangement 1110. Community member identifier 1118 may be the same or similar as user identifier 620 associated with the particular user. Community member identifier 1118 may be distinguished (e.g., by being boxed or colored differently) than community member identifiers 1116 to allow the user to quickly and easily visually identify and distinguish himself/herself within hub-and-spoke arrangement 1110.

The hub (e.g., media asset identifier 1112) and each spoke (e.g., community member identifier 1116) may connected by links 1114. Different links 1114 may be used to represent a different type of connection to media asset identifier 1112. For example, one link 1114 may be a solid line while another link 1114 may be a dashed line. Also, different colors may be used to indicate different connection types. Additionally, colors and types of lines (e.g., solid or dashed) may be used in combination to indicate a variety of different connections or similarities. The links may indicate the same or similar connections as those discussed above in connection with FIG. 6. For example, a dashed link may indicate that the particular community member corresponding to the community member identifier 1116 has previously watched, recorded, scheduled for recording or had a reminder set or stored for a media asset corresponding to media asset identifier 1112. In some implementations, solid links may indicate that the particular community member corresponding to community member identifier 1116 has never accessed the media asset corresponding to media asset identifier 1112.

When the user positions a cursor over one of related media asset identifier 1120 or 1122 or one of community member identifiers 1116, processing circuitry 306 may automatically display information about the media asset corresponding to related media asset identifier 1120 or 1122 or the community member corresponding to community member identifier 1116 over which the cursor is positioned. For example, when the user positions a cursor over one of other media asset identifiers 1120, processing circuitry 306 may display a window next to related media asset identifier 1120 over which the cursor is positioned that includes information about the media asset corresponding to related media asset identifier 1120. In some implementations, instead of or in addition to displaying the information in a window, the information about the media asset may be provided in place of or within media asset identifier region 1130. In particular, when the cursor is positioned over a particular community member identifier 1116, processing circuitry 306 may display a window with information and functionality similar to window 810 (FIG. 8). Alternatively, when the cursor is positioned over a particular related media asset identifier 1120, processing circuitry 306 may display a window with information and functionality similar to window 710 (FIG. 7). In some embodiments, when the media asset corresponding to related media asset identifier 1120 is a music asset, processing circuitry 306 may automatically begin playing back a song or music associated with the music asset when the cursor is positioned over related media asset identifier 1120.

In some embodiments, when a cursor is positioned over a particular community member identifier 1116, processing circuitry 306 may display information associated with a profile data structure 900 corresponding to community member identifier 1116 in media asset identifier region 1130. For example, as shown in FIG. 12, a display 1200 is provided which includes a user identification information region corresponding to a community member identifier over which a cursor is positioned. In particular, when a cursor 1210 is positioned over community member 1220, information associated with that community member is displayed in community member identification region 1230. In some implementations, community member identification region 1230 may be displayed when the user presses a suitable button or command after positioning cursor 1210 over community member identifier 1220. In some other implementations, community member identification region 1230 may be displayed automatically as cursor 1210 is positioned over community member identifier 1220.

Information and options included in community member identification region 1230 may be the same or similar to those discussed in connection with user identifier region 670 (FIG. 6). Processing circuitry 306 may retrieve a profile data structure 900 (FIG. 9) associated with a community member corresponding to community member identifier 1220 over which the cursor is positioned. Processing circuitry 306 may generate community member identification region 1230 based on the information extracted from the retrieved profile data structure 900.

In some embodiments, a user may press a help key on a remote control or select a help option (not shown) from a display screen. As a result, processing circuitry 306 may display help information in a window on the display or as a new screen which may include navigation information on how to operate or use the community or network. The help key or help option may be selected while browsing any one of the displays discussed above and below. The help information may indicate what certain items that are displayed mean. For example, the help information may provide a key to the user that informs the user about what various indicators on the screen mean. In particular, the help information may inform the user what a dashed link in a hub-and-spoke arrangement represents and similarly what a solid link represents. Additionally, the help information may inform the user about what the various types of identifiers in the hub-and-spoke arrangements represent. In some implementations, the help information may be provided when the user positions a cursor over a particular identifier or link for a predetermined period of time (e.g., more than five seconds) without user action. The help information may be displayed in a window and may be tailored specifically to the item over which the cursor is positioned.

As discussed above, the user may search the community or network for a particular TV Show, user, media asset or other information. In some embodiments, after processing circuitry 306 performs the search, processing circuitry 306 may generate for display the search results in a hub-and-spoke arrangement. For example, processing circuitry 306 may generate for display a search term identifier corresponding to the search term received through text box 520 (FIG. 5) substantially in the center of the hub-and-spoke arrangement. Processing circuitry 306 may visually join or link the search term identifier to identifiers corresponding to results of the executed search. More specifically, processing circuitry 306 may display the search results identifiers corresponding to the search term substantially around or about the search term identifier displayed in the center of the hub-and-spoke arrangement.

Each search result identifier may be an individual identifier that may be an icon, a video, an animation, a graphic image that allows the user to visually determine the media asset, user or information that corresponds to that search result identifier. Processing circuitry 306 may include in the results display recommendations that do not match the search term explicitly but, based on the user's profile, processing circuitry 306 determines the user may have an interest in the recommendations. These recommended results may be visually distinguished from the search results identifiers that explicitly match the search term (e.g., by using a different icon, color or identifier to represent them). Identifiers corresponding to the recommendations may not be linked or joined to the search term identifier and may be displayed around the hub-and-spoke arrangement in a similar manner as related media assets 1120 and 1122 (FIG. 11) are displayed. The hub-and-spoke arrangement may look and function in a similar manner as the profile or media asset hub and spoke arrangements discussed above in connection with FIGS. 6-8, 11 and 12. As the user positions a cursor over one of the displayed search results identifiers, information associated with that search result may be displayed in a window or in a search result identification region similar to media asset identification region 1130 (FIG. 11).

The user may search for other users or media assets by specifying corresponding criteria in menu 522. The operation is similar to that described above except the system searches a field in a database that corresponds to the field selected in menu 520 (FIG. 5). In some implementations, the user may execute a brute force search by selecting an all fields option from menu 520 which may cause processing circuitry 306 to search every field in the database for the text the user enters in text box 520. The results may be displayed as discussed above in an interactive search results hub-and-spoke arrangement.

As discussed above, when processing circuitry 306 receives a user selection of network connections option 560 (FIG. 5), processing circuitry 306 may generate a display screen 1300 (FIG. 13). Display screen 1300 may include preferences relating to the community or network or other members as a whole (e.g., the favorite item amongst all the users within the user's community).

FIG. 13 shows an illustrative display screen 1300 of community preferences as a whole in accordance with an embodiment of the invention. Screen 1300 may include a community preferences region 1310 and a network map region 1320. Community preferences region 1310 may include a list of information relating to best matches or most popular of various fields in the database of the entire community. Community preferences region 1310 gives the user a global perspective of the likes/dislikes of the community or network as a whole. For example, community preferences region 1310 may identify to the user the name of the movie that matches most or all of the preferences of profiles of the members in the community. In particular, community preferences region 1310 may indicate that the favorite movie among the members of the community is “The Shawshank Redemption.” More specifically, processing circuitry 306 may determine that the movie “The Shawshank Redemption” is included as the favorite movie in a majority of the profiles stored in the network or community.

Processing circuitry 306 may include in community preferences region 1310 the best matched item for each field in the profile data structures stored in the community or network. In some implementations, the user may specify which and how many of the fields to include in community preferences region 1310. For example, the user may specify that only the favorite movie and the favorite director should be included in community preferences region 1310. Accordingly, processing circuitry 306 may only search the favorite movie and director fields of the profile data structures to determine which movie and director the majority of community members prefer. The user may limit the number of profiles which processing circuitry 306 searches to determine the best match or favorite to only those that are friends with the user. Alternatively, the user instruct processing circuitry 306 to search all the profiles stored in the network or community to determine the best match or favorite in the entire network.

Processing circuitry 306 may include in the community preferences region 1310 the number of users which had profile data structures with the favorite item among the community. For example, when processing circuitry 306 determines that the favorite movie is “The Shawshank Redemption,” processing circuitry 306 may count and provide the number of profile data structures which included that movie as a favorite. In some embodiments, processing circuitry 306 may display the username or name of the community member which is most active within the community. In particular, the most active member may be one that is logged in for the most amount of time, sends the most amount of messages, has the most number of items in common with other members of the community or has the most amount of friends in the community. Similarly, processing circuitry 306 may identify the most active geographic region or group of members within the community. For example, processing circuitry 306 may indicate that New York region has the most number of active members in a global company community.

Network map region 1320 may include a map of the various geographic regions in which members of the community are located. For example, when the community is a company, network map region 1320 may be a global map with the various office locations of the company highlighted. The map included in network map region 1320 may be interactive such that the user may position a cursor over a particular region and select the region. Each of the displayed regions may include a number corresponding to the number of users which are located in that geographic region. When processing circuitry 306 receives a user selection of one of the regions from network map region 1320, processing circuitry 306 may navigate the user to a display screen which includes information specific to the selected region.

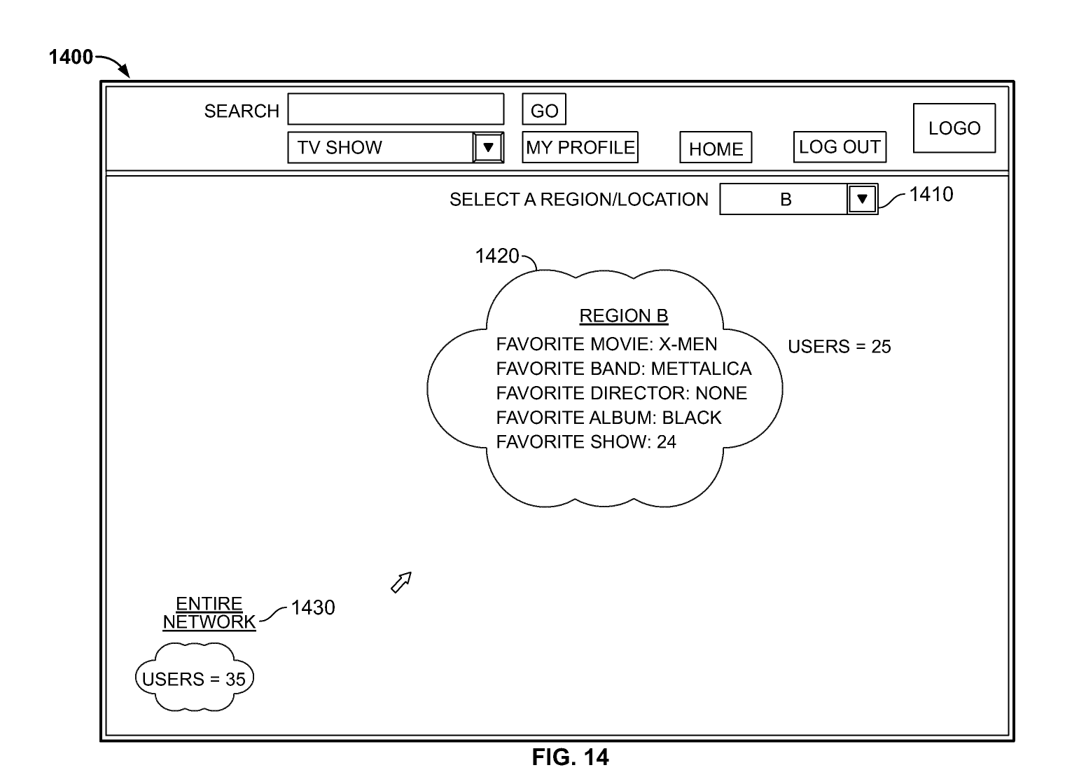

FIG. 14 shows an illustrative display screen 1400 of region specific preferences in accordance with an embodiment of the invention. Screen 1400 may include a region selection menu 1410, region specific preferences region 1420 and an entire network region 1430. Region selection menu 1410 may allow the user to select one or more of the geographic regions of the community or network in which members of the community are located. For example, in a company community, the user may select an option to view the favorites in one of the regions in which the company has offices. When the user selects, for example, New York region in region selection menu 1410, region specific preferences region 1420 may be displayed that provides the favorites in that specific selected region. The user may then select another region from region selection menu 1410 to cause an additional region specific preferences region (not shown) to be displayed with information specific to the selected region. The region specific preferences regions 1420 may be displayed separately or simultaneously in the same display to allow the user to easily compare the favorites and preferences among the different geographic regions of the community.

Region specific preferences region 1420 may include a list of information relating to best matches or most popular of various fields in the database of the selected geographic region of the community. Region specific preferences region 1420 gives the user a region specific perspective of the likes/dislikes of the region of the community or network as a whole. For example, region specific preferences region 1420 may identify to the user the name of the band that matches most or all of the preferences of profiles of the members in the selected region of the community. In particular, region specific preferences region 1420 may indicate that the favorite band among the members of the selected region of the community is “Mettalica.” More specifically, processing circuitry 306 may determine that the band “Mettalica” is included as the favorite band in a majority of the profiles stored in the network or community for the selected region of the community.

The user may select any one of the displayed items in the lists displayed in regions 1310 and 1420 to add the particular media asset or preference to a profile data structure associated with the user. For example, the user may position a cursor over the favorite album preference in region specific preferences region 1420 to select the specified favorite album. As a result, processing circuitry 306 may include the selected album as the favorite album field in profile data structure 900 (FIG. 9) associated with the user. In some implementations, processing circuitry 306 may allow the user to view a photograph, icon, playback or access a media asset or view a clip associated with any one of the favorite items included in regions 1420 or 1310.

In some embodiments, processing circuitry 306 may display a map of the globe in screen 1400 and highlight regions in which members of the community are located within the displayed globe. Processing circuitry 306 may cause region 1420 to be displayed close in proximity to the selected geographic locations on the map. For example, when the New York region is selected in menu 1410, region 1420 of favorite preferences may be positioned over the United States part of the map and when the Tokyo region is selected in menu 1410, region 1420 of favorite preferences may be positioned over Asia in the displayed map.

Processing circuitry 306 may receive a user selection of entire network region 1430. As a result, processing circuitry 306 may generate display 1300 discussed above that includes favorite preferences of the network or community as a whole.

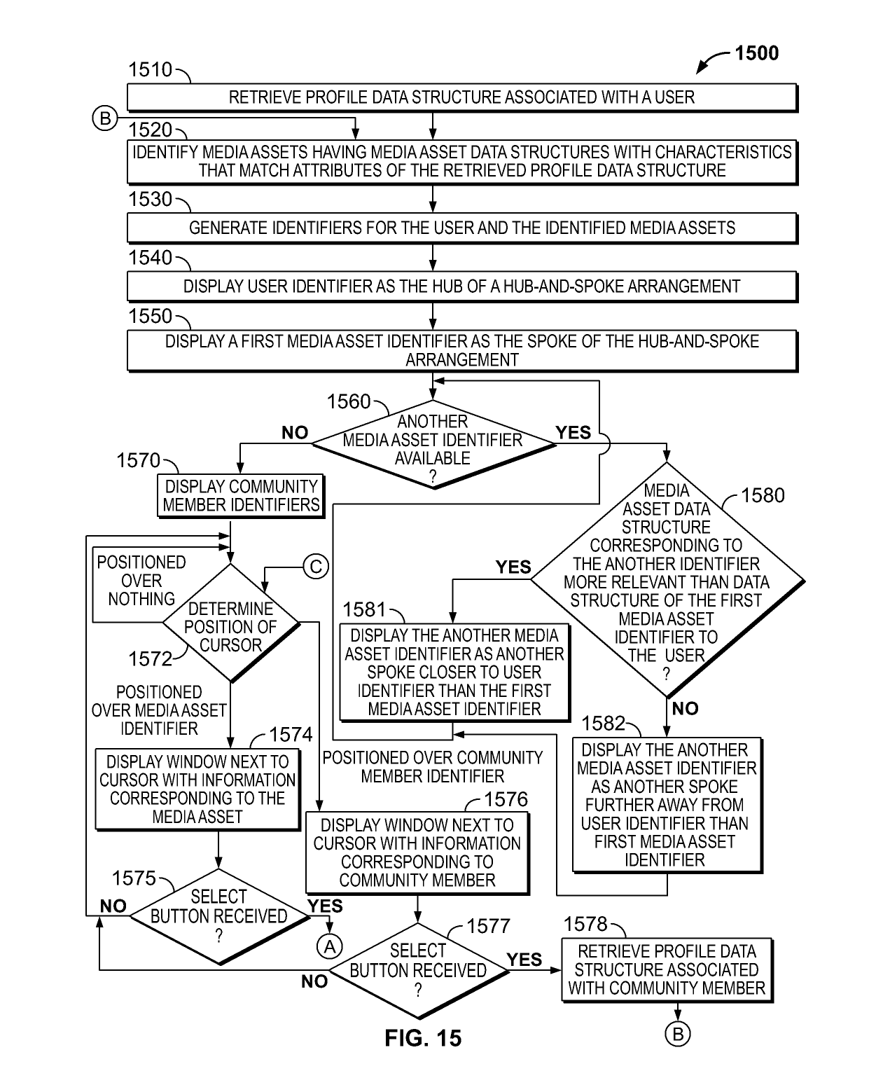

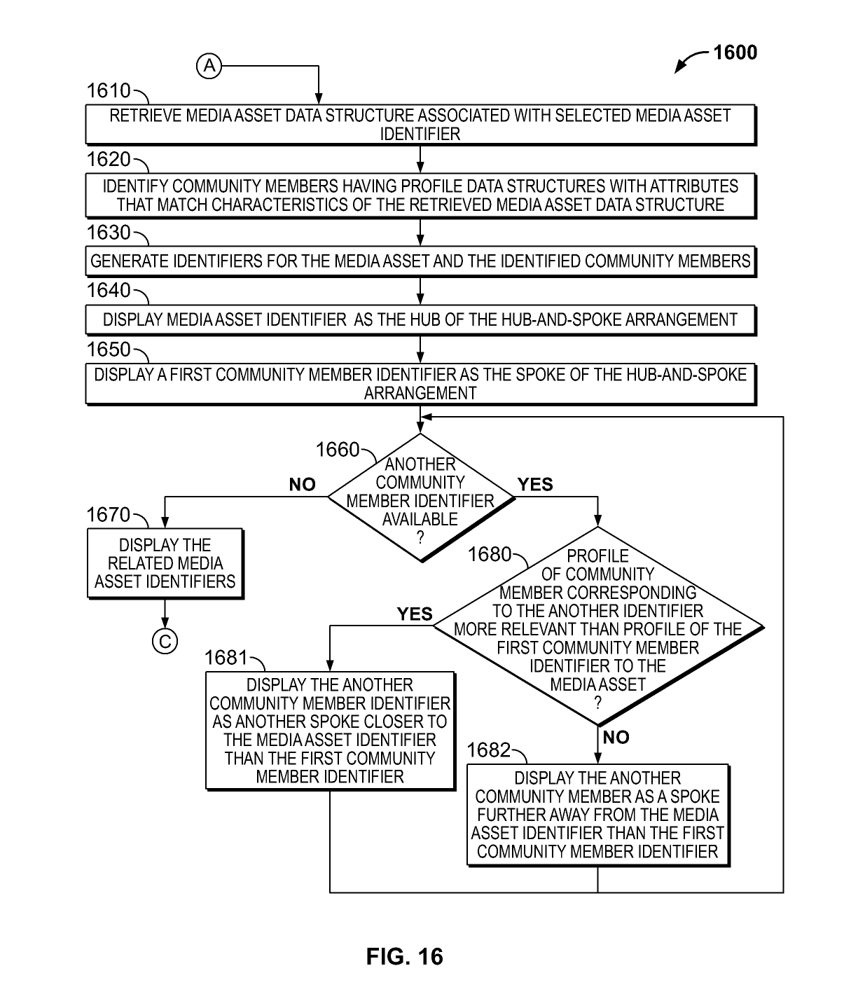

FIGS. 15 and 16 are illustrative flow diagrams 1500 and 1600 for providing community based hub-and-spoke arrangements in accordance with embodiments of the present invention. At step 1510, a profile data structure associated with a user is retrieved from memory. For example, processing circuitry 306 may determine who the user viewing the screen is by retrieving the login credentials and may retrieve profile data structure 900 (FIG. 9) corresponding to the determined user from memory.

At step 1520, media assets having media asset data structures with characteristics that match attributes of the retrieved profile data structure are identified. For example, processing circuitry 306 may analyze and identify preferences or attributes from the various fields in profile data structure 900 associated with the user. Processing circuitry 306 may then search fields within media asset data structures 1000 (FIG. 10) stored in memory (locally or remotely) to identify media asset data structures 1000 that meet preferences of profile data structure 900. In particular, when profile data structure 900 has a field indicating an interest in comedy and action media assets, processing circuitry 306 may retrieve from memory media asset data structures 1000 having fields with comedy and/or action characteristics.

At step 1530, identifiers for the user and the identified media assets are generated. For example, processing circuitry 306 may generate or retrieve a picture, photograph, icon or some other representation for the user profile data structure 900 and each of the identified media asset data structures 1000.

At step 1540, the user identifier is displayed as the hub of a hub-and-spoke arrangement. For example, as shown in FIG. 6, a profile hub-and-spoke arrangement 610 may be generated and displayed with user identifier 620 being included as the hub of hub-and-spoke arrangement 610.

At step 1550, a first media asset identifier is displayed as the spoke of the hub-and-spoke arrangement. For example, a first media asset identifier 630 may be included as the spoke of hub-and-spoke arrangement 610 (FIG. 6).

At step 1560, a determination is made as to whether another media asset identifier is available. When another media asset identifier is available, the process continues to step 1580, otherwise the process continues to step 1570. For example, processing circuitry 306 may count how many media asset data structures 1000 are identified and may determine how many media asset identifiers have been generated. When less media asset identifiers are generated than the media asset data structures that are identified, processing circuitry 306 may determine that another media asset identifier is available.

At step 1570, community member identifiers are displayed. For example, processing circuitry 306 may determine who the friends of the user corresponding to user identifier 620 are by, for example, retrieving a friends list from a field of the retrieved profile data structure 900. Processing circuitry 306 may generate community member identifiers 650 for each friend in the list and include those identifiers in the display (e.g., next to hub-and-spoke arrangement 610).

At step 1572, a determination is made as to the position of a cursor on the screen. When the cursor is determined to be positioned over no object on the screen, the process returns to step 1572; when the cursor is determined to be positioned over a media asset identifier of the hub-and-spoke arrangement, the process continues to step 1574; and when the cursor is determined to be positioned over a community member identifier, the process continues to step 1576.

At step 1574, a window is displayed next to the cursor that includes information corresponding to the media asset associated with the media asset identifier over which the cursor is positioned. For example, processing circuitry 306 may generate a window 710 (FIG. 7) for display next to media asset identifier 720 over which cursor 770 is positioned.

At step 1575, a determination is made as to whether a select or confirm action key or button is received. When a select or confirm action key or button is received, the process continues to step 1610 (FIG. 16), otherwise, the process returns to step 1572.

At step 1610, a media asset data structure associated with the selected media asset identifier is retrieved from memory.

At step 1620, community members having profile data structures with attributes that match characteristics of the retrieved media asset data structure are identified. For example, processing circuitry 306 may analyze and identify preferences or attributes from the various fields in media asset data structure 1000 (FIG. 10) associated with the media asset. Processing circuitry 306 may then search fields within profile data structures 900 (FIG. 9) stored in memory (locally or remotely) to identify profile data structures 900 that have preferences that match attributes of media asset data structure 1000. In particular, when media asset data structure 1000 has a field indicating that the media asset has comedy and action characteristics, processing circuitry 306 may retrieve from memory profile data structures 900 (of community members) having fields indicating preferences for media assets with comedy and/or action characteristics.

At step 1630, identifiers for the media asset corresponding to the selected media asset identifier and the identified community members are generated. For example, processing circuitry 306 may generate or retrieve a picture, photograph, icon or some other representation for the media asset data structure 1000 and each of the identified profile data structures 900.

At step 1640, the media asset identifier is displayed as the hub of the hub-and-spoke arrangement. For example, as shown in FIG. 11, a media asset hub-and-spoke arrangement 1110 may be generated and displayed with media asset identifier 1112 being included as the hub of hub-and-spoke arrangement 1110.

At step 1650, a first community member identifier is displayed as the spoke of the hub-and-spoke arrangement. For example, a first community member identifier 1116 may be included as the spoke of media asset hub-and-spoke arrangement 1110 (FIG. 11).

At step 1660, a determination is made as to whether another community member identifier is available. When another community member identifier is available, the process continues to step 1680, otherwise the process continues to step 1670. For example, processing circuitry 306 may count how many profile data structures 900 are identified and may determine how many community member identifiers have been generated. When less community member identifiers are generated than the profile data structures that are identified, processing circuitry 306 may determine that another community member identifier is available.

At step 1670, related media asset identifiers are displayed. For example, processing circuitry 306 may search for and find media asset data structures 1000 that are related to (e.g., have similar characteristics) as media asset data structure 1000 corresponding to media asset identifier 1112. Processing circuitry 306 may determine which media assets are related by, for example, retrieving a related media assets list from a field of the retrieved media asset data structure 1000 associated with media asset identifier 1112. Processing circuitry 306 may generate related media asset identifiers 1120 and 1122 for each media asset in the list and include those identifiers in the display (e.g., next to hub-and-spoke arrangement 1110). The process then continues to step 1572 (FIG. 15).

At step 1680, a determination is made as to whether a profile corresponding to the another community member identifier is more relevant to the media asset than the profile of the first community member identifier. When the profile is more relevant, the process continues to step 1681, otherwise the process continues to step 1682. For example, processing circuitry 306 may compute (1) a Euclidean distance between preferences of the profile data structure associated with the first community member and a media asset data structure associated with the media asset and (2) a Euclidean distance between preferences of the profile data structure associated with the another community member and a media asset data structure associated with the media asset. A higher value for the Euclidean distance may indicate that there is a smaller correlation between the profile and the media asset (e.g., the media asset is less relevant to the user associated with that profile). A lower value for the Euclidean distance may indicate that there is a higher correlation between the profile and the media asset (e.g., the media asset is more relevant to the user associated with that profile).

At step 1681, the other community member identifier is displayed as another spoke of the hub-and-spoke arrangement closer to the media asset identifier (the hub) than the first community member identifier. For example, when processing circuitry 306 determines that the media asset associated with the identifier is more relevant to the other community member, processing circuitry 306 may generate in the hub-and-spoke arrangement the community member identifier as a spoke close in distance to the media asset identifier than the first community member identifier.

At step 1682, the other community member identifier is displayed as another spoke of the hub-and-spoke arrangement farther away from the media asset identifier (the hub) than the first community member identifier. For example, when processing circuitry 306 determines that the media asset associated with the identifier is less relevant to the other community member, processing circuitry 306 may generate in the hub-and-spoke arrangement the community member identifier as a spoke farther in distance to the media asset identifier than the first community member identifier.

Referring back to step 1572 (FIG. 15), when the cursor is positioned over a community member identifier, at step 1576, a window is displayed next to the cursor that includes information corresponding to the community member associated with the community member identifier over which the cursor is positioned. For example, processing circuitry 306 may generate a window 810 (FIG. 8) for display next to community member identifier 820 over which cursor 830 is positioned.

At step 1577, a determination is made as to whether a select or confirm action key or button is received. When a select or confirm action key or button is received, the process continues to step 1578 (FIG. 16), otherwise, the process returns to step 1572.

At step 1578, a profile data structure associated with the community member corresponding to the community member identifier over which the cursor is positioned is retrieved from memory. The process then continues to step 1520.

Referring back to step 1560, when another media asset identifier is available, at step 1580, a determination is made as to whether a media asset data structure corresponding to the another media asset identifier is more relevant to the user than the data structure of the first media asset identifier. When the media asset data structure is more relevant, the process continues to step 1581, otherwise the process continues to step 1582. For example, processing circuitry 306 may compute a (1) Euclidean distance between attributes of the media asset data structure associated with the first media asset identifier and a profile data structure associated with the user and (2) a Euclidean distance between attributes of the media asset data structure associated with the another media asset identifier and a profile data structure associated with the user.

At step 1581, the other media asset identifier is displayed as another spoke of the hub-and-spoke arrangement closer to the user identifier (the hub) than the first media asset identifier. For example, when processing circuitry 306 determines that the media asset associated with the media asset identifier is more relevant to the user, processing circuitry 306 may generate in the hub-and-spoke arrangement the media asset identifier as a spoke closer in distance to the user identifier than the first media asset identifier.

At step 1582, the other media asset identifier is displayed as another spoke of the hub-and-spoke arrangement farther away from the user identifier (the hub) than the first media asset identifier. For example, when processing circuitry 306 determines that the media asset associated with the media asset identifier is less relevant to the user, processing circuitry 306 may generate in the hub-and-spoke arrangement the media asset identifier as a spoke farther in distance to the user identifier than the first media asset identifier.

It should be understood, that the above steps of the flow diagrams of FIGS. 15 and 16 may be executed or performed in any order or sequence no limited to the order and sequence shown and described in the figures. Also, some of the above steps of the flow diagrams of FIGS. 15 and 16 may be executed or performed substantially simultaneously where appropriate or in parallel to reduce latency and processing times.

The above described embodiments of the present invention are presented for purposes of illustration and not of limitation, and the present invention is limited only by the claims which follow.

1. A method for visually linking media assets with user profiles, the method comprising:
storing a first preference profile associated with a first user;
identifying a plurality of media assets that match preferences of the first preference profile; and
generating for display a first interactive hub-and-spoke arrangement, wherein:
a first indicator associated with the first preference profile is included in the hub of the first hub and spoke arrangement; and
a plurality of second indicators each associated with a different one of the plurality of media assets are included in the spokes of the first hub-and-spoke arrangement.

2. The method of claim 1 further comprising displaying the first interactive hub-and-spoke arrangement.

3. The method of claim 1 wherein a first distance between one of the second indicators and the first indicator is shorter than a second distance between a second one of the second indicators and the first indicator.

4. The method of claim 3 wherein the first distance indicates that the media asset associated with the one of the second indicators is more closely linked to the preferences in the preference profile than the media asset associated with the second one of the second indicators.

5. The method of claim 3 wherein the first distance indicates that the media asset associated with the one of the second indicators is more relevant to the user than the media asset associated with the second one of the second indicators.

6. The method of claim 1 further comprising:
positioning a cursor over one of the plurality of second indicators; and
generating for display, next to the one of the plurality of second indicators, a window that includes information about the media asset associated with the one of the plurality of second indicators.

7. The method of claim 6 wherein the window further includes a video clip corresponding to the media asset associated with the one of the plurality of second indicators.

8. The method of claim 1 further comprising identifying a plurality of users that are in a same social network as the first user.

9. The method of claim 8 wherein the social network is a company, a branch of a company, a group of friends or a group of colleagues.

10. The method of claim 8 further comprising generating for display with the first interactive hub-and-spoke arrangement a plurality of third indicators each associated with a different one of the identified plurality of users.

11. The method of claim 10 further comprising:
displaying the plurality of third indicators;
receiving a user selection of one of the displayed third indicators;
retrieving a second preference profile associated with a second user corresponding to the selected one of the third indicators; and
identifying a second plurality of media assets that match preferences of the second preference profile.

12. The method of claim 11 further comprising:
generating for display a second interactive hub-and-spoke arrangement, wherein:
a third indicator associated with the second preference profile is included in the hub of the second hub and spoke arrangement; and
a plurality of fourth indicators each associated with a different one of the second plurality of media assets are included in the spokes of the first hub and spoke arrangement.

13. The method of claim 1 further comprising:
displaying the first interactive hub-and-spoke arrangement;
receiving a user selection of one of the second indicators associated with a first of the plurality of media assets; and
identifying a plurality of preference profiles that each have at least one preference that matches the first media asset.

14. The method of claim 13 further comprising:
generating for display a second interactive hub-and-spoke arrangement, wherein:
a third indicator associated with the first media asset is included in the hub of the second interactive hub and spoke arrangement; and
a plurality of fourth indicators each associated with a different one of the plurality of preference profiles are included in the spokes of the second interactive hub and spoke arrangement.

15. The method of claim 14 wherein the first and second interactive hub-and-spoke arrangements are displayed together.

16. The method of claim 14 wherein the first and second interactive hub-and-spoke arrangements are displayed in separate displays one at a time.

17. The method of claim 14 further comprising identifying a plurality of media assets that are related to the first media asset.

18. The method of claim 17 further comprising generating for display with the second interactive hub-and-spoke arrangement a plurality of fifth indicators each associated with a different one of the identified plurality of media assets.

19. A system for visually linking media assets with user profiles, the system comprising:
a memory; and
processing circuitry configured to:
store in the memory a first preference profile associated with a first user;
identify a plurality of media assets that match preferences of the first preference profile; and
generate for display a first interactive hub-and-spoke arrangement, wherein:
a first indicator associated with the first preference profile is included in the hub of the first hub and spoke arrangement; and
a plurality of second indicators each associated with a different one of the plurality of media assets are included in the spokes of the first hub-and-spoke arrangement.

20. The system of claim 19 further comprising a display for displaying the first interactive hub-and-spoke arrangement.

21. The system of claim 19 wherein a first distance between one of the second indicators and the first indicator is shorter than a second distance between a second one of the second indicators and the first indicator.

22. The system of claim 21 wherein the first distance indicates that the media asset associated with the one of the second indicators is more closely linked to the preferences in the preference profile than the media asset associated with the second one of the second indicators.

23. The system of claim 21 wherein the first distance indicates that the media asset associated with the one of the second indicators is more relevant to the user than the media asset associated with the second one of the second indicators.

24. The system of claim 19 further comprising:
a user input device;
wherein the processing circuitry is further configured to:
receive indication from the user input device to position a cursor over one of the plurality of second indicators; and
generate for display, next to the one of the plurality of second indicators, a window that includes information about the media asset associated with the one of the plurality of second indicators.

25. The system of claim 24 wherein the window further includes a video clip corresponding to the media asset associated with the one of the plurality of second indicators.

26. The system of claim 19 wherein the processing circuitry is further configured to identify a plurality of users that are in a same social network as the first user.

27. The system of claim 26 wherein the social network is a company, a branch of a company, a group of friends or a group of colleagues.

28. The system of claim 26 wherein the processing circuitry is further configured to generate for display with the first interactive hub-and-spoke arrangement a plurality of third indicators each associated with a different one of the identified plurality of users.

29. The system of claim 28 further comprising:
a display for displaying the plurality of third indicators;
wherein the processing circuitry is further configured to:
receive a user selection of one of the displayed third indicators;
retrieve a second preference profile associated with a second user corresponding to the selected one of the third indicators; and
identify a second plurality of media assets that match preferences of the second preference profile.

30. The system of claim 29 wherein the processing circuitry is further configured to:
generate for display a second interactive hub-and-spoke arrangement, wherein:
a third indicator associated with the second preference profile is included in the hub of the second hub and spoke arrangement; and
a plurality of fourth indicators each associated with a different one of the second plurality of media assets are included in the spokes of the first hub and spoke arrangement.

31. The system of claim 19 further comprising:
a display for displaying the first interactive hub-and-spoke arrangement;
wherein the processing circuitry is further configured to:
receive a user selection of one of the second indicators associated with a first of the plurality of media assets; and
identify a plurality of preference profiles that each have at least one preference that matches the first media asset.

32. The system of claim 31 wherein the processing circuitry is further configured to:
generate for display a second interactive hub-and-spoke arrangement, wherein:
a third indicator associated with the first media asset is included in the hub of the second interactive hub and spoke arrangement; and
a plurality of fourth indicators each associated with a different one of the plurality of preference profiles are included in the spokes of the second interactive hub and spoke arrangement.

33. The system of claim 32 wherein the first and second interactive hub-and-spoke arrangements are displayed together.

34. The system of claim 32 wherein the first and second interactive hub-and-spoke arrangements are displayed in separate displays one at a time.

35. The system of claim 32 wherein the processing circuitry is further configured to identify a plurality of media assets that are related to the first media asset.

36. The system of claim 35 wherein the processing circuitry is further configured to generate for display with the second interactive hub-and-spoke arrangement a plurality of fifth indicators each associated with a different one of the identified plurality of media assets.

37-54. (canceled)
